(19) United States
(12) Patent Application Publication
(10) Pub. No.: US 2014/0119650 A1
(43) Pub. Date: May 1, 2014

(54) IMAGE PROCESSING DEVICE, IMAGE PROCESSING METHOD, AND IMAGE PROCESSING PROGRAM

(71) Applicant: Sony Corporation, Minato-ku (JP)

(72) Inventor: Changbo Zhou, Tokyo (JP)

(73) Assignee: SONY CORPORATION, Minato-ku (JP)

(21) Appl. No.: 14/031,407

(22) Filed: Sep. 19, 2013

(30) Foreign Application Priority Data
Oct. 25, 2012 (JP) 2012-235272

(51) Int. Cl. G06T 5/00

(52) U.S. Cl. CPC G06T 5/00
USPC 382/167

(57) ABSTRACT

An image processing device includes: a detecting section configured to detect, from a frame image, a local-maximum region that is configured of pixels each having a color-difference signal value larger than color-difference signal values of surrounding pixels; a determining section configured to determine an overlapping region where the local-maximum region overlaps with a first neighboring region of a pixel of interest that belongs to the local-maximum region, and to determine a minimum of color-difference signal values of pixels that belong to the overlapping region; and a correcting section configured to correct a color-difference signal of the pixel of interest, based on both a color-difference signal value of the pixel of interest and the minimum of the color-difference signal values of pixels that belong to the overlapping region.

### CROSS REFERENCE TO RELATED APPLICATIONS

This application claims the benefit of Japanese Priority Patent Application JP 2012-235272 filed Oct. 25, 2012, the entire contents of which are incorporated herein by reference.

### BACKGROUND

The present disclosure relates to an image processing device that processes an image signal, and an image processing method and an image processing program for use in the image processing device.

Images picked up by a video camera that takes moving pictures, a digital camera that takes still pictures, and the like may suffer what is called “color fringing” (also called “fringe” or “aberration”). This color fringing causes a region with a large luminance difference in an image to be shown in a color different from the original color, such as red, blue or purple. Such color fringing occurs due to the color aberration of a lens, or blooming of an image sensor. The color fringing is likely to become more prominent when a compact lens, a high-magnification lens, or a low-cost image sensor is used.

Since this color fringing degrades the quality of an image, it is necessary to discriminate and reduce color fringing. There are some techniques that reduce color fringing. For example, Japanese Unexamined Patent Application Publication No. 2011-205477 discloses an image processing device that discriminates the direction in which the luminance monotonously decreases starting at a pixel causing color fringing, and corrects the color of the pixel causing color fringing based on the color of a pixel at which the monotonous reduction in that direction stops. Japanese Unexamined Patent Application Publication No. 2009-268033 discloses an image processing device that estimates the intensity of color fringing in a region where color fringing occurs according to a difference in the signal intensity between a plurality of color planes that constitutes a color image, and subtracts the estimated intensity of color fringing from the intensity of color fringing in the color fringing region. Japanese Unexamined Patent Application Publication No. 2009-055610 discloses an image processing device that calculates a first weight representing the degree of chromatic aberration based on the difference between gradients of color components, calculates a second weight representing the degree of chromatic aberration based on gradients of luminance components, and corrects the chrominance of a pixel based on the first weight and the second weight.

### SUMMARY

It is apparently desirable and expected to further reduce color fringing in a photographed image.

It is desirable to provide an image processing device, an image processing method, and an image processing program that are capable of reducing color fringing.

An image processing device according to an embodiment of the present disclosure includes: a detecting section configured to detect, from a frame image, a local-maximum region that is configured of pixels each having a color-difference signal value larger than color-difference signal values of surrounding pixels; a determining section configured to determine an overlapping region where the local-maximum region overlaps with a first neighboring region of a pixel of interest that belongs to the local-maximum region, and to determine a minimum of color-difference signal values of pixels that belong to the overlapping region; and a correcting section configured to correct a color-difference signal of the pixel of interest, based on both a color-difference signal value of the pixel of interest and the minimum of the color-difference signal values of pixels that belong to the overlapping region.

An image processing method according to an embodiment of the present disclosure includes: detecting, from a frame image, a local-maximum region that is configured of pixels each having a color-difference signal value larger than color-difference signal values of surrounding pixels; determining an overlapping region where the local-maximum region overlaps with a first neighboring region of a pixel of interest that belongs to the local-maximum region; determining a minimum of color-difference signal values of pixels that belong to the overlapping region; and correcting a color-difference signal of the pixel of interest, based on both a color-difference signal value of the pixel of interest and the minimum of the color-difference signal values of pixels that belong to the overlapping region.

A non-transitory tangible medium according to an embodiment of the present disclosure has a computer-readable program embodied therein. The computer-readable program allows, when executed by an image processing device, the image processing device to implement an image processing method. The method includes: detecting, from a frame image, a local-maximum region that is configured of pixels each having a color-difference signal value larger than color-difference signal values of surrounding pixels; determining an overlapping region where the local-maximum region overlaps with a first neighboring region of a pixel of interest that belongs to the local-maximum region; determining a minimum of color-difference signal values of pixels that belong to the overlapping region; and correcting a color-difference signal of the pixel of interest, based on both a color-difference signal value of the pixel of interest and the minimum of the color-difference signal values of pixels that belong to the overlapping region.

According to the image processing device, the image processing method, and the image processing program of the above-described respective embodiments of the present disclosure, the local-maximum region in the frame image is detected, and the minimum of color-difference signal values is determined on the basis of the detected local-maximum region. Further, the color-difference signal is corrected based on the color-difference signal value and the minimum of the color-difference signal values. In this process, the minimum of the color-difference signal values is determined in the overlapping region where the local-maximum region overlaps with the first neighboring region of the pixel of interest belonging to the local-maximum region.

According to the image processing device, the image processing method, and the image processing program of the above-described respective embodiments of the present disclosure, the minimum of the color-difference signal values of the pixels that belong to the overlapping region, where the local-maximum region overlaps with the first neighboring region of the pixel of interest that belongs to the local-maximum region, is determined. Also, the color-difference signal is corrected, based on based on both the color-difference signal value and the minimum of the color-difference signal values. Therefore, it is possible to reduce color fringing.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram showing a configurational example of an image processing device according to an embodiment of the present disclosure.

FIG. 2 is an explanatory diagram showing an example of color fringing.

FIG. 3A is an explanatory diagram showing an example of a luminance signal and a chroma signal before correction.

FIG. 3B is an explanatory diagram showing an example of a luminance signal and a chroma signal after correction.

FIG. 4 is a table illustrating an operational example of integrators shown in FIG. 1.

FIG. 5 is an explanatory diagram illustrating an operational example of the integrators shown in FIG. 1.

FIG. 6 is an explanatory diagram illustrating an operational example of the integrators and subtracters shown in FIG. 1.

FIG. 7 is a table illustrating an operational example of the integrators shown in FIG. 1.

FIG. 8 is an explanatory diagram illustrating an operational example of a gain map generator shown in FIG. 1.

FIG. 9 is a table illustrating an operational example of a local-maximum-region detector shown in FIG. 1.

FIG. 10A is an explanatory diagram showing an operational example of the local-maximum-region detector shown in FIG. 1.

FIG. 10B is an explanatory diagram showing another operational example of the local-maximum-region detector shown in FIG. 1.

FIG. 11 is an explanatory diagram showing an example of a local-maximum region detected by the local-maximum-region detector shown in FIG. 1.

FIG. 12 is a table illustrating an operational example of a minimum-value detector shown in FIG. 1.

FIG. 13 is an explanatory diagram showing an operational example of the minimum-value detector and a local-maximum-region map generator shown in FIG. 1.

FIG. 14 is an explanatory diagram showing an operational example of the local-maximum-region map generator shown in FIG. 1.

FIG. 15 is a block diagram showing a configurational example of an image processing device according to a modification.

FIG. 16 is a block diagram showing a configurational example of an image processing device according to another modification.

FIG. 17 is a block diagram showing a configurational example of an image processing device according to a further modification.

FIG. 18 is a block diagram showing a configurational example of an image processing device according to a still further modification.

FIG. 19A is an explanatory diagram illustrating an operational example of a gain calculating section according to a yet still further modification.

FIG. 19B is an explanatory diagram illustrating an operational example of the gain calculating section according to a yet still further modification.

FIG. 20 is a block diagram showing a configurational example of an image processing device according to a yet still further modification.

FIG. 21 is a block diagram showing a configurational example of an image processing device according to a yet still further modification.

FIG. 22 is an explanatory diagram illustrating an operational example of a gain calculating section and a local-maximum-region calculating section according to a yet still further modification.

FIG. 23 is a block diagram showing a configurational example of an image processing device according to a yet still further modification.

### DETAILED DESCRIPTION

An embodiment according to the present disclosure is described below referring to the accompanying drawings.

### Configurational Example

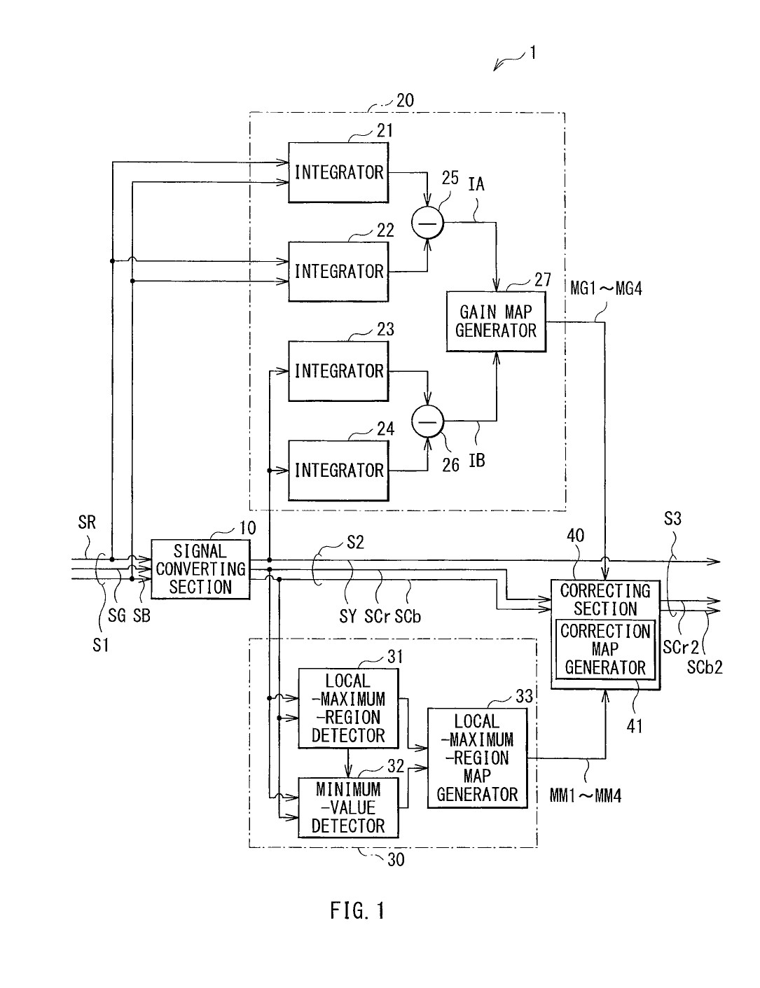

FIG. 1 shows a configurational example of an image processing device according to one embodiment. This image processing device 1 reduces what is called “color fringing” which causes a region with a large luminance difference in an image to be shown in red, blue, purple or the like. Because an image processing method and an image processing program according to an embodiment of the present disclosure are achieved by this embodiment, the method and program are described collectively.

The image processing device 1 includes a signal converting section 10, a gain calculating section 20, a local-maximum-region calculating section 30, and a correcting section 40. The image processing device 1 performs color-fringing correction on an input image signal S1 to reduce color fringing, thereby generating an image signal S3.

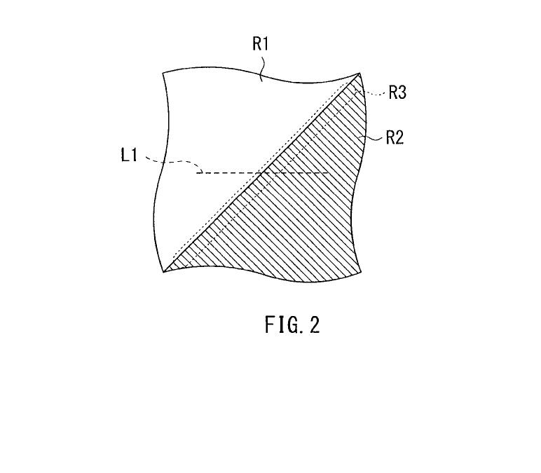

FIG. 2 shows an example of color fringing on a frame image. In this frame image, a high-luminance region R1 and a low-luminance region R2 are adjacent each other. In such a case, color fringing is likely to occur in the neighborhood (region R3) of the boundary between the high-luminance region R1 and the low-luminance region R2.

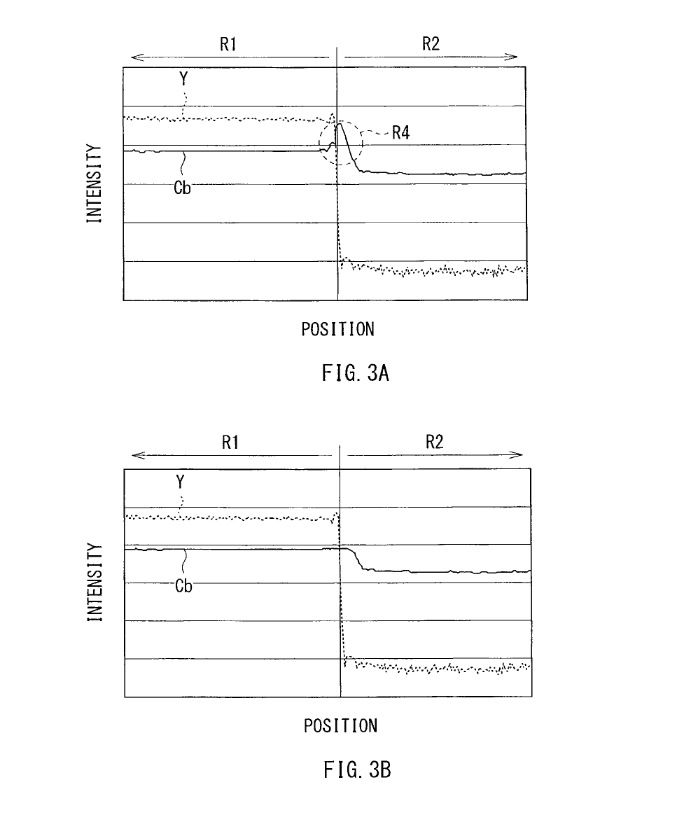

FIG. 3A shows an example of a luminance signal Y along line L1 (luminance signal SY to be described later) and a chroma signal Cb for blue (B) (chroma signal SCb to be described later) when the colors of the individual pixels in the frame image shown in FIG. 2 are expressed in YCbCr space. FIG. 3B shows an example of a chroma signal Cb after correction of color fringing (chroma signal SCb2 to be described later).

As shown in FIG. 3A, the intensity of the chroma signal Cb is higher in the neighborhood (region R4) of the boundary between the high-luminance region R1 and the low-luminance region R2 than that in a surrounding region. In such a region (local-maximum region A), blue different from the original color is shown, so that an observer feels as if color blurs from the high-luminance region R1 to the low-luminance region R2. Apparently, color fringing may occur in a region showing a large luminance difference in an image at near the boundary between the high-luminance region and the low-luminance region.

In correcting color fringing, the signal intensity of the region R4 of the chroma signal Cb as shown in FIG. 3A may be reduced to, for example, a signal intensity as shown in FIG. 3B. This makes it less likely that the neighborhood of the boundary appears bluish, thus suppressing color fringing there.

Although the description of this example has been given of the chroma signal Cb by way of example, the same is true of a chroma signal Cr for red (R). That is, the color is shown reddish in a region where the intensity of the chroma signal Cr is higher than that in a surrounding region, causing color fringing. Even in this case, it is possible to suppress this color fringing by performing the color-fringing correction as shown in FIG. 3B.

The image processing device 1 performs color-fringing correction on the image signal S1 to reduce color fringing thereof. The image signal S1 is a so-called RGB signal including a color signal SR of red (R), a color signal SG of green (G), and a color signal SB of blue (B) in this example. It is to be noted that hereinafter, whenever appropriate, a color plane PLR is used to express color signals SR for a single frame image, a color plane PLG is used to express color signals SG for a single frame image, and a color plane PLB is used to express color signals SB for a single frame image.

The signal converting section 10 converts the image signal S1 which is an RGB signal into an image signal S2 which is an YCbCr signal. This image signal S2 includes the luminance signal SY, a chroma signal SCb for blue (B), and a chroma signal SCr for red (R). The conversion of the RGB signal into the YCbCr signal may be executed by using, for example, the following expression.

$$\begin{matrix}[ EQ . 1 ] & \\ \begin{matrix}Y = 0.299 \times R + 0.578 \times G + 0.114 \times B \\ Cb = - 0.169 \times R - 0.331 \times G + 0.5 B \\ Cr = 0.5 \times R - 0.418 \times G + 0.082 \times B\end{matrix} \} & ( 1 )\end{matrix}$$

It is also to be noted that hereinafter, whenever appropriate, a luminance plane PLY is used to express luminance signals SY for a single frame image, a chroma plane PLCb is used to express chroma signals SCb for a single frame image, and a chroma plane PLCr is used to express chroma signals SCr for a single frame image.

In this example, the image signal S2 is an YCbCr signal, which is not restrictive, and may be an Lab signal, an HSV signal, a YUV signal, a YIQ signal or the like instead. For the Lab signal, the L signal represents the luminance, and the “a” signal and the “b” signal represent chroma. For the HSV signal, the H signal represents the luminance, and the S signal and the V signal represent chroma. For the YUV signal, the Y signal represents the luminance, and the U signal and the V signal represent chroma. For the YIQ signal, the Y signal represents the luminance, and the I signal and the Q signal represent chroma.

The gain calculating section 20 sequentially selects the pixels forming a frame image, and determines a gain G for each selected pixel (pixel P of interest) based on the image signals S1 and S2, generating four gain maps MG1 to MG4. The gain calculating section 20 includes integrators 21 to 24, subtracters 25 and 26, and a gain map generator 27. As will be described later, the gain maps MG1 to MG4 which are generated by the gain calculating section 20 correspond to four combinations for two directions (horizontal direction and vertical direction) of integration in the integrators 21 to 24, and two targets for integration (color signals SR and SB) in the integrators 21 and 22.

The integrators 21 and 22 integrate the color signals SR and SB over a predetermined zone near the pixel P of interest based on the image signal S1. Specifically, as will be described later, for example, the integrator 21 may integrate the color signals SR at a predetermined number N1 of pixels located to the left of the pixel P of interest to determine an average value, and the integrator 22 may likewise integrate the color signals SR at the predetermined number N1 of pixels located to the right of the pixel P of interest to determine an average value. This predetermined number N1 may be set to, for example, about 1/200 of the number of pixels of the frame image in the lengthwise direction. Further, for example, the integrator 21 may integrate the color signals SR at the predetermined number N1 of pixels located above the pixel P of interest to determine an average value, and the integrator 22 may likewise integrate the color signals SR at the predetermined number N1 of pixels located below the pixel P of interest to determine an average value. The integrators 21 and 22 may likewise perform integration on color signals SB to determine an average value.

The subtracter 25 determines an absolute value of the difference between the result of the operation performed by the integrator 21 and the result of the operation performed by the integrator 22, and outputs the absolute value as a difference signal IA. Accordingly, as will be described later, the subtracter 25 outputs a large-value difference signal IA for a region in the frame image where the color signals SR and SB vary significantly.

The integrators 23 and 24 integrate the luminance signals SY over a predetermined zone near the pixel P of interest based on the image signal S2. Specifically, as will be described later, for example, the integrator 23 may integrate the luminance signals SY at the predetermined number N1 of pixels located to the left of the pixel P of interest to determine an average value, and the integrator 24 may likewise integrate the luminance signals SY at the predetermined number N1 of pixels located to the right of the pixel P of interest to determine an average value. Further, for example, the integrator 23 may integrate the luminance signals SY at the predetermined number N1 of pixels located above the pixel P of interest to determine an average value, and the integrator 24 may likewise integrate the luminance signals SY at the predetermined number N1 of pixels located below the pixel P of interest to determine an average value.

The subtracter 26 determines an absolute value of the difference between the result of the operation performed by the integrator 23 and the result of the operation performed by the integrator 24, and outputs the absolute value as a difference signal IB. Accordingly, as will be described later, the subtracter 26 outputs a large-value difference signal IB for a region in the frame image where the luminance signal SY varies significantly. In other words, the difference signal IB takes a large value in a region with a large luminance difference where color fringing is likely to occur.

The gain map generator 27 determines a gain G for each pixel based on the difference signals IA and IB, and generates four gain maps MG1 to MG4 containing the gain G as an element. The gain maps MG1 to MG4 correspond to four combinations for two directions (horizontal direction and vertical direction) of integration in the integrators 21 to 24, and two targets for integration (color signals SR and SB) in the integrators 21 and 22. In this example, the gain G is equal to or larger than 0 and equal to or less than 1, and takes a larger value for a region where the luminance signal SY and the color signals SR and SB vary significantly. It is to be noted that the range for the gain G is not restrictive; for example, the upper limit of the range may be larger than 1, or may be smaller than 1.

The local-maximum-region calculating section 30 sequentially selects the pixels forming a frame image, and detects local-maximum regions A of the chroma signals SCr and SCb in the frame image included in the image signal S2, thereby generating local-maximum-region maps MM1 to MM4. The local-maximum-region calculating section 30 includes a local-maximum-region detector 31, a minimum-value detector 32, and a local-maximum-region map generator 33. As will be described later, the local-maximum-region maps MM1 to MM4 generated by the local-maximum-region calculating section 30 correspond to four combinations for two directions (horizontal direction and vertical direction) of the operations performed by the local-maximum-region detector 31 and the minimum-value detector 32, and two targets (chroma signals SCr and SCb).

The local-maximum-region detector 31 sequentially selects the pixels forming a frame image, and compares the chroma signals SCb and SCr at the selected pixel (pixel P of interest) with the chroma signals SCr and SCb at pixels other than those located near the pixel P of interest, to detect a local-maximum region A (region R4 in FIG. 3A) of each of the chroma signals SCr and SCb in the frame image. Specifically, as will be described later, for example, the local-maximum-region detector 31 may determine the difference between the chroma signal SCr at the pixel P of interest and the chroma signal SCr at each of four pixels separated from that pixel P of interest by a predetermined number N2 or more in the horizontal direction, and may determine that the pixel P of interest belongs to the local-maximum region A in the horizontal direction of the chroma plane PLCr when all of the differences are equal to or larger than a predetermined threshold value thc. This predetermined number N2 may be set to, for example, about 1/200 of the number of pixels of the frame image in the lengthwise direction. Further, the local-maximum-region detector 31 may determine the difference between the chroma signal SCr at the pixel P of interest and the chroma signal SCr at each of four pixels separated from that pixel P of interest by the predetermined number N2 or more in the vertical direction, and may determine that the pixel P of interest belongs to the local-maximum region A in the vertical direction of the chroma plane PLCr when all of the differences are equal to or larger than the predetermined threshold value thc. The local-maximum-region detector 31 may likewise detect local-maximum regions A for the chroma signal SCb. The local-maximum-region detector 31 supplies the positions of the pixels forming the local-maximum regions A to the minimum-value detector 32 as a map. The local-maximum-region detector 31 supplies the chroma signals SCr and SCb at pixels belonging to the local-maximum regions A to the local-maximum-region map generator 33.

Although the local-maximum-region detector 31 compares the chroma signals SCb and SCr at the pixel P of interest with the chroma signals SCr and SCb at four pixels other than those located near the pixel P of interest in this example, the number of pixels to be comparison targets is not limited to four, and may be three or less, or may be five or larger.

The minimum-value detector 32 sequentially selects the pixels forming the local-maximum region A detected by the local-maximum-region detector 31, and determines a minimum value Min of each of the chroma signals SCr and SCb in a predetermined zone near the selected pixel (pixel P of interest) and corresponding to the local-maximum region A. Specifically, as will be described later, for example, the minimum-value detector 32 may determine a minimum value Min of the chroma signals SCr at pixels included in those pixels located within a zone of a predetermined number N3 from the pixel P of interest in the horizontal direction and which belong to the local-maximum region A. This predetermined number N3 may be set to, for example, about 1/200 of the number of pixels of the frame image in the lengthwise direction. Also, the minimum-value detector 32 may determine a minimum value Min of the chroma signals SCr at pixels included in those pixels located within a zone of the predetermined number N3 from the pixel P of interest in the vertical direction and which belong to the local-maximum region A. The minimum-value detector 32 may likewise determine minimum value Min for the chroma signals SCb.

The local-maximum-region map generator 33 determines a local-maximum region value E for each pixel based on the difference between the chroma signals SCr and SCb at each of the pixels forming the local-maximum region A detected by the local-maximum-region detector 31 and the minimum values Min of the chroma signals SCr and SCb detected by the minimum-value detector 32, and generates four local-maximum-region maps MM1 to MM4 containing this local-maximum region value E as an element. The local-maximum-region maps MM1 to MM4 correspond to four combinations for two directions (horizontal direction and vertical direction) of the operations performed by the local-maximum-region detector 31 and the minimum-value detector 32, and two targets (chroma signals SCr and SCb).

The correcting section 40 corrects the chroma signals SCb and SCr based on the gain maps MG1 to MG4 supplied from the gain calculating section 20 and the four local-maximum-region maps MM1 to MM4 supplied from the local-maximum-region calculating section 30.

The correcting section 40 includes a correction map generator 41. The correction map generator 41 generates four correction maps MAP1 to MAP4 containing a correction amount M for each pixel as an element, based on the gain maps MG1 to MG4 and the local-maximum-region maps MM1 to MM4. The correcting section 40 corrects the chroma signals SCb and SCr based on the correction maps MAP1 to MAP4, generating chroma signals SCb2 and SCr2.

With this configuration, the image processing device 1 performs color-fringing correction on the image signal S1 to reduce color fringing thereof, generating the image signal S3 containing the luminance signal SY and the chroma signals SCb2 and SCr2.

The local-maximum-region detector 31 corresponds to a specific example of the “detecting section” according to an embodiment of the disclosure. The minimum-value detector 32 corresponds to a specific example of the “determining section” according to an embodiment of the disclosure. The local-maximum-region map generator 33 and the correcting section 40 correspond to a specific example of the “correcting section” according to an embodiment of the disclosure. The gain calculating section 20 corresponds to a specific example of the “gain determining section” according to an embodiment of the disclosure. The signal converting section 10 corresponds to a specific example of the “converting section” according to an embodiment of the disclosure.

[Operation and Effects]

Next, operation and effects of the image processing device 1 according to the embodiment are described.

(Outline of General Operation)

First, referring to FIG. 1, the outline of the general operation of the image processing device 1 is described. The signal converting section 10 converts the image signal S1 which is an RGB signal into the image signal S2 which is an YCbCr signal.

The integrators 21 and 22 in the gain calculating section 20 sequentially select the pixels forming a frame image, and integrate the color signals SR and SB over a predetermined zone near the selected pixel (pixel P of interest) based on the image signal S1. The subtracter 25 determines the absolute value of the difference between the result of the arithmetic operation performed by the integrator 21 and the result of the arithmetic operation performed by the integrator 22, and outputs the absolute value as the difference signal IA. The integrators 23 and 24 sequentially select the pixels forming the frame image, and integrate the luminance signals SY over a predetermined zone near the selected pixel (pixel P of interest) based on the image signal S2. The subtracter 26 determines the absolute value of the difference between the result of the arithmetic operation performed by the integrator 23 and the result of the arithmetic operation performed by the integrator 24, and outputs the absolute value as the difference signal IB. The gain map generator 27 generates four gain maps MG1 to MG4 based on the difference signals IA and IB.

The local-maximum-region detector 31 in the local-maximum-region calculating section 30 detects the local-maximum region A in the frame image based on each of the chroma signals SCr and SCb of the image signal S2. The minimum-value detector 32 sequentially selects the pixels forming the local-maximum region A detected by the local-maximum-region detector 31, and determines the minimum value Min of each of the chroma signals SCr and SCb in a predetermined zone near the selected pixel (pixel P of interest) and corresponding to the local-maximum region A. The local-maximum-region map generator 33 generates four local-maximum-region maps MM1 to MM4 based on the chroma signals SCr and SCb at each of the pixels forming the local-maximum region A detected by the local-maximum-region detector 31, and the minimum values Min of the chroma signals SCr and SCb which are detected by the minimum-value detector 32.

The correcting section 40 generates four correction maps MAP1 to MAP4 based on the gain maps MG1 to MG4 supplied from the gain calculating section 20 and the local-maximum-region maps MM1 to MM4 supplied from the local-maximum-region calculating section 30, and corrects the chroma signals SCb and SCr based on the correction maps MAP1 to MAP4, thereby generating the chroma signals SCb2 and SCr2.

Then, the operations of the gain calculating section 20, the local-maximum-region calculating section 30, and the correcting section 40 are described in detail.

(Operation of Gain Calculating Section 20)

The integrators 21 and 22 sequentially select the pixels forming the frame image, and integrate the color signals SR and SB over a predetermined zone near the selected pixel (pixel P of interest).

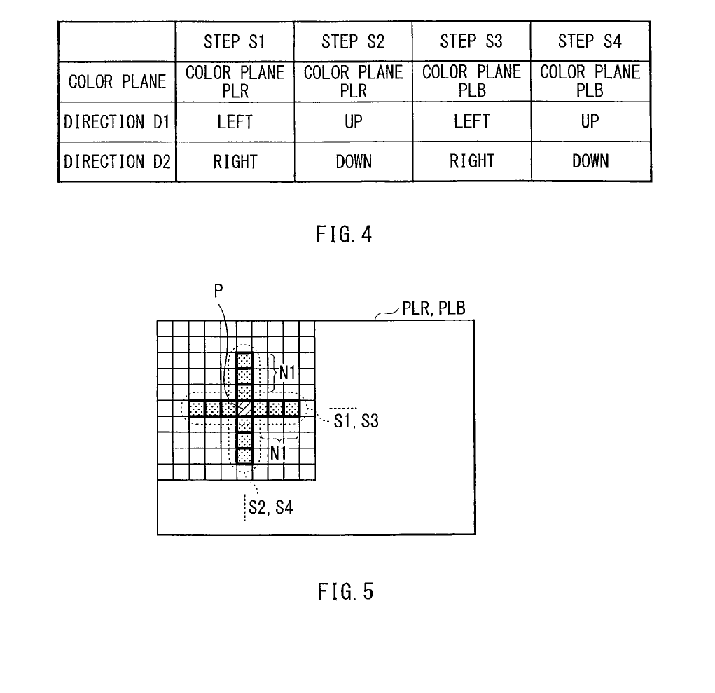

FIG. 4 illustrates the operations of the integrators 21 and 22. FIG. 5 exemplarily illustrates the operations of the integrators 21 and 22. The integrators 21 and 22 execute four steps S1 to S4 as illustrated in FIGS. 4 and 5. The integrators 21 and 22 integrate the color signals SR over a predetermined zone near the pixel P of interest using the color plane PLR (color signals SR for a single frame image) in steps S1 and S2, and integrate the color signals SB over a predetermined zone near the pixel P of interest using the color plane PLB (color signals SB for a single frame image) in steps S3 and S4. In other words, an arithmetic operation for reducing reddish color fringing is performed in steps S1 and S2, and an arithmetic operation for reducing bluish color fringing is performed in steps S3 and S4. In executing the arithmetic operations, the integrators 21 and 22 perform an integration operation in the horizontal direction in steps S1 and S3, and perform an integration operation in the vertical direction in steps S2 and S4. In other words, the integrators 21 and 22 perform the integration operation in steps S1 and S3 in the direction crossing the direction of the integration operation performed in steps S2 and S4. In steps S1 to S4, a direction D1 and a direction D2 are point symmetrical to each other with respect to the pixel P of interest.

Specifically, in step S1, the integrator 21 integrates the color signals SR at a predetermined number N1 of pixels located to the left (direction D1) of the pixel P of interest using the color plane PLR to determine an average value for each pixel. Likewise, the integrator 22 integrates the color signals SR at the predetermined number N1 of pixels located to the right (direction D2) of the pixel P of interest using the color plane PLR to determine an average value for each pixel.

In step S2, the integrator 21 integrates the color signals SR at the predetermined number N1 of pixels located above (direction D1) the pixel P of interest using the color plane PLR to determine an average value for each pixel. Likewise, the integrator 22 integrates the color signals SR at the predetermined number N1 of pixels located below (direction D2) the pixel P of interest using the color plane PLR to determine an average value for each pixel.

In step S3, the integrator 21 integrates the color signals SB at the predetermined number N1 of pixels located to the left (direction D1) of the pixel P of interest using the color plane PLB to determine an average value for each pixel. Likewise, the integrator 22 integrates the color signals SB at the predetermined number N1 of pixels located to the right (direction D2) of the pixel P of interest using the color plane PLB to determine an average value for each pixel.

In step S4, the integrator 21 integrates the color signals SB at the predetermined number N1 of pixels located above (direction D1) the pixel P of interest using the color plane PLB to determine an average value for each pixel. Likewise, the integrator 22 integrates the color signals SB at the predetermined number N1 of pixels located below (direction D2) the pixel P of interest using the color plane PLB to determine an average value for each pixel.

Then, in each of steps S1 to S4, the subtracter 25 determines the absolute value of the difference between the result of the arithmetic operation performed by the integrator 21 and the result of the arithmetic operation performed by the integrator 22 for each pixel P of interest, and outputs the absolute value as the difference signal IA.

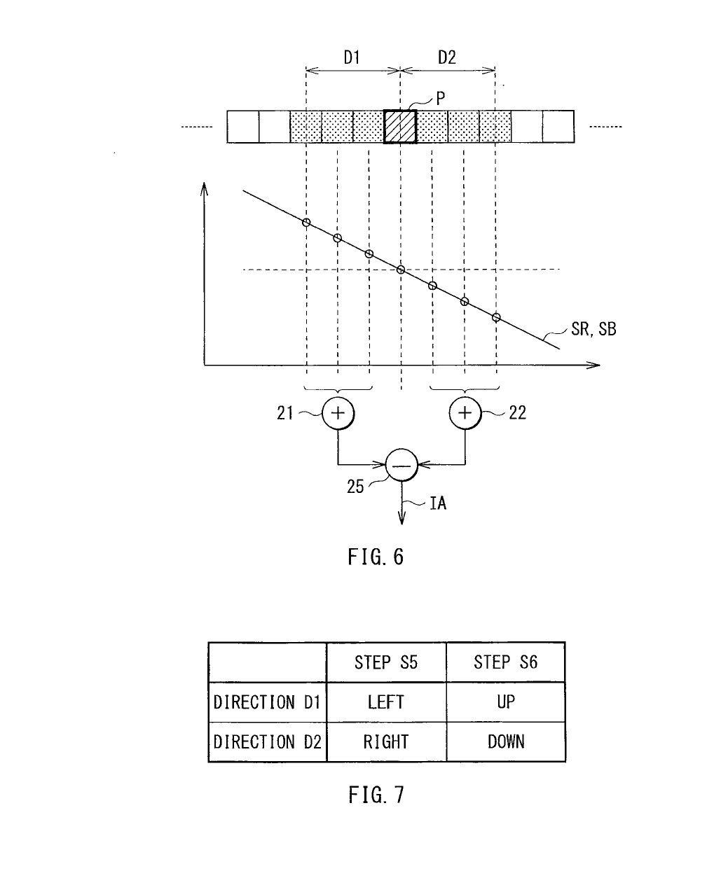

FIG. 6 exemplarily illustrates the operations of the integrators 21 and 22 and the subtracter 25 in each of steps S1 to S4. The difference signal IA output from the subtracter 25 may get larger in steps S1 and S2 when a variation in color signal SR becomes larger, and may get larger in steps S3 and S4 when a variation in color signal SB becomes larger.

The subtracter 25 determines the difference signal IA for each pixel P of interest in this manner. Then, the subtracter 25 determines the difference signals IA for all the pixels in each of steps S1 to S4, and outputs the difference signals IA as the four maps corresponding to the respective steps S1 to S4.

The integrators 23 and 24 sequentially select the pixels forming the frame image, and integrate the luminance signals SY in a predetermined zone near the selected pixel (pixel P of interest).

FIG. 7 illustrates the operations of the integrators 23 and 24. The integrators 23 and 24 execute two steps S5 and S6 as illustrated in FIG. 4. The integrators 23 and 24 integrate the luminance signals SY over a predetermined zone near the pixel P of interest using the luminance plane PLY (luminance signals SY for a single frame image). In executing the arithmetic operations, the integrators 23 and 24 perform an integration operation in the horizontal direction in step S5, and perform an integration operation in the vertical direction in step S6. The arithmetic operations of the integrators 23 and 24 in steps S5 and S6 are the same as the arithmetic operations (FIG. 5) of the integrators 21 and 22 in steps S1 to S4.

Specifically, in step S5, the integrator 23 integrates the luminance signals SY at a predetermined number N1 of pixels located to the left (direction D1) of the pixel P of interest using the luminance plane PLY to determine an average value for each pixel. Likewise, the integrator 24 integrates the luminance signals SY at the predetermined number N1 of pixels located to the right (direction D2) of the pixel P of interest using the luminance plane PLY to determine an average value for each pixel.

In step S6, the integrator 23 integrates the luminance signals SY at the predetermined number N1 of pixels located above (direction D1) the pixel P of interest using the luminance plane PLY to determine an average value for each pixel. Likewise, the integrator 24 integrates the luminance signals SY at the predetermined number N1 of pixels located below (direction D2) the pixel P of interest using the luminance plane PLY to determine an average value for each pixel.

Then, in each of steps S5 and S6, the subtracter 26 determines the absolute value of the difference between the result of the arithmetic operation performed by the integrator 23 and the result of the arithmetic operation performed by the integrator 24 for each selected pixel P of interest, and outputs the absolute value as the difference signal IB. The difference signal IB output from the subtracter 26, like the difference signal IA output from the subtracter 25 (FIG. 6), may get larger when a variation in luminance signal becomes larger.

The subtracter 26 determines the difference signal IB for each pixel P of interest in this manner. Then, the subtracter 26 determines the difference signals IB for all the pixels in each of steps S5 and S6, and outputs the difference signals IB as two maps corresponding to the respective steps S5 and S6.

The gain map generator 27 generates four gain maps MG1 to MG4 having the gains G at the individual pixels as elements based on the four maps for the difference signal IA generated in steps S1 to S4, and the two maps for the difference signal IB generated in steps S5 and S6.

Specifically, based on the values (difference signals IA and IB) for the same pixel in the map for the difference signal IA generated in step S1 and the map for the difference signal IB generated in step S5, the gain map generator 27 determines the gain G for that pixel to generate the gain map MG1. Likewise, the gain map generator 27 generates the gain map MG2 based on the map for the difference signal IA generated in step S2 and the map for the difference signal IB generated in step S6, generates the gain map MG3 based on the map for the difference signal IA generated in step S3 and the map for the difference signal IB generated in step S5, and generates the gain map MG4 based on the map for the difference signal IA generated in step S4 and the map for the difference signal IB generated in step S6.

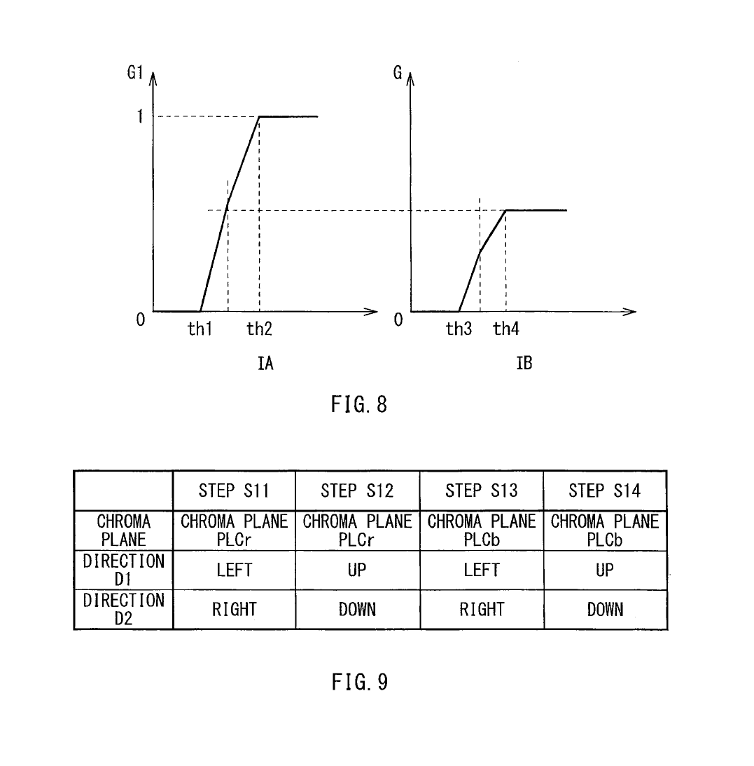

FIG. 8 illustrates the operation to determine the gain G at a pixel based on the difference signals IA and IB at that pixel. In this example, the gain G is determined in two steps illustrated below.

First, the gain map generator 27 substitutes the difference signal IA in the following expression to determine a gain G1.

$$\begin{matrix}[ EQ . 2 ] & \\ G 1 = \{ \begin{matrix}0 & ( I A ≦ th 1 ) \\ \frac{I A - th 1}{th 2 - th 1} & ( th 1 < I A < th 2 ) \\ 0 & ( th 2 ≦ I A )\end{matrix} & ( 2 )\end{matrix}$$

That is, the gain G1 is a linear function of the difference signal IA within the zone where the intensity of the difference signal IA is larger than a value th1 and less than a value th2.

Next, the gain map generator 27 substitutes the gain G1 determined by the expression 2 and the difference signal IA in the following expression to determine the gain G

$$\begin{matrix}[ EQ . 3 ] & \\ G = \{ \begin{matrix}0 & ( I B ≦ th 3 ) \\ G 1 \times \frac{I B - th 3}{th 4 - th 3} & ( th 3 < I B < th 4 ) \\ 0 & ( th 4 ≦ I B )\end{matrix} & ( 3 )\end{matrix}$$

That is, the gain G is a linear function of the difference signal IB within the zone where the intensity of the difference signal IB is larger than a value th3 and less than a value th4.

Although the gains G1 and G are linear functions in predetermined zones in this example, the gains G1 and G may be functions that monotonously vary like a quadratic curve, a cubic curve or a spline curve. The gain map generator 27 determines the gain G in two steps in this example, which is not restrictive, and may be determined in one step using a function of two variables. In this example, the gain G is determined using a function, which is not restrictive. Instead of using a function, for example, an LUT (Look-Up Table) may be used to determine the gain G.

As shown in FIG. 8 and the expressions 2 and 3, the gain G gets larger when each of the difference signals IA and IB becomes larger. In other words, the gain G gets larger when a variation in luminance signal SY becomes larger, and likewise gets larger when a variation in each of the color signals SR and SB becomes larger. Apparently, the gain calculating section 20 is configured to increase the gain G in a region in a frame image where a variation in luminance signal SY is large. This makes it possible to efficiently reduce color fringing. That is, since color fringing is likely to occur in a region in a frame image where the luminance difference is large, as shown in FIG. 2, increasing the gain G in such a region makes it possible to efficiently reduce color fringing.

In addition, the gain calculating section 20 is provided with the integrators 21 and 22 and the subtracter 25 to increase the gain G even in a region in a frame image where a variation in color signal SR or SB is large, thus making it possible to further reduce color fringing. Without the integrators 21 and 22 and the subtracter 25, for example, the gain G is generated based on the luminance signal SY. In this case, it is difficult to separately perform color-fringing correction on the chroma signals SCr and SCb. In such case, when color fringing occurs for one of red and blue, for example, color-fringing correction is performed for a color plane that does not show color fringing as well as a color plane that shows color fringing, which may lower the image quality. By way of contrast, the gain calculating section 20 is provided with the integrators 21 and 22 and the subtracter 25 to generate the gain maps MG1 and MG2 based on the color signal SR and the luminance signal SY, and generate the gain maps MG3 and MG4 based on the color signal SB and the luminance signal SY. In this case, when reddish color fringing is more intense than bluish color fringing, for example, color-fringing correction mainly on the chroma signal SCr makes it possible to suppress the influence of correction for the color plane PLB. Likewise, when bluish color fringing is more intense than reddish color fringing, for example, color-fringing correction mainly on the chroma signal SCb makes it possible to suppress the influence of correction for the color plane PLR.

In the gain calculating section 20, the integrators 21 to 24 integrate the color signals SR and SB, and the luminance signals SY, and determines the gain G based on the results of the integration. Even when the color signals SR and SB, or the luminance signals SY contain noise, therefore, it is possible to suppress the influence of noise on the arithmetic operation for color correction. According to the image processing device described in Japanese Unexamined Patent Application Publication No. 2011-205477, for example, the direction in which the luminance monotonously decreases and the amount of color correction may be shifted, lowering the correction accuracy. The image processing device described in Japanese Unexamined Patent Application Publication No. 2009-55610 corrects the chroma of pixels based on the difference in gradient between color components or the difference in gradient between luminance components, so that noise may lower the correction accuracy. By way of contrast, the integrators 21 to 24 in the gain calculating section 20 determine the gain G based on the values of integration of the color signals SR and SB, and the luminance signals SY. Even when the color signals SR and SB, or the luminance signals SY contain noise, therefore the noise component is smoothed, thus making it possible to suppress the influence of noise on the arithmetic operation for color correction.

In the gain calculating section 20, the integrators 21 to 24 perform the calculation for integration to determine an average value for each pixel, making it possible to simplify the operation in the gain map generator 27. If the integrators 21 to 24 perform only the arithmetic processing for integration, and the subtracters 25 and 26, and the gain map generator 27 perform arithmetic operations based on the results of integration, for example, it is necessary for the gain map generator 27 to change the values th1 to th4 in the expressions 2 and 3 to determine the gain G according to the predetermined number N1. If the predetermined number N1 is changed, the arithmetic processing may become complex. By way of contrast, each of the integrators 21 to 24 in the gain calculating section 20 determines an average value by dividing the result of integration by the predetermined number N1. Accordingly, the gain map generator 27 prevents the values th1 to th4 from depending on the predetermined number N1, thus making it possible to simplify the arithmetic processing.

(Operation of Local-Maximum-Region Calculating Section 30)

The local-maximum-region detector 31 sequentially selects the pixels forming the frame image, and compares the chroma signals SCr and SCb at the selected pixel (pixel P of interest) with the chroma signals SCr and SCb at pixels other than those located near the pixel P of interest, to detect the local-maximum regions A of the chroma signals SCr and SCb in the frame image.

FIG. 9 illustrates the operation of the local-maximum-region detector 31. The local-maximum-region detector 31 executes four steps S11 to S14 as shown in FIG. 9. The local-maximum-region detector 31 detects the local-maximum region A of the chroma signal Cr using the chroma plane PLCr (chroma signals Cr for a single frame image) in steps S11 and S12, and detects the local-maximum region A of the chroma signal Cb using the chroma plane PLCb (chroma signals Cb for a single frame image) in steps S13 and S14. In other words, an arithmetic operation for reducing reddish color fringing is performed in steps S11 and S12, and an arithmetic operation for reducing bluish color fringing is performed in steps S13 and S14. In executing the arithmetic operations, the local-maximum-region detector 31 performs an integration operation in the horizontal direction in steps S11 and S13, and performs an integration operation in the vertical direction in steps S12 and S14.

Specifically, in step S11, using the chroma plane PLCr, the local-maximum-region detector 31 determines the difference between the chroma signal SCr at the pixel P of interest and the chroma signal SCr at each of a total of four pixels, namely two pixels separated leftward (direction D1) by a predetermined number N2 or more from the pixel P of interest as a reference and two pixels separated rightward (direction D2) by the predetermined number N2 or more from the pixel P of interest as the reference, and determines that the pixel P of interest forms the local-maximum region A of the chroma plane PLCr in the horizontal direction, when every one of the differences is equal to or larger than the predetermined threshold value thc.

In step S12, using the chroma plane PLCr, the local-maximum-region detector 31 determines the difference between the chroma signal SCr at the pixel P of interest and the chroma signal SCr at each of a total of four pixels, namely two pixels separated upward (direction D1) by the predetermined number N2 or more from the pixel P of interest as the reference and two pixels separated downward (direction D2) by the predetermined number N2 or more from the pixel P of interest as the reference, and determines that the pixel P of interest forms the local-maximum region A of the chroma plane PLCr in the vertical direction, when every one of the differences is equal to or larger than the predetermined threshold value thc.

In step S13, using the chroma plane PLCb, the local-maximum-region detector 31 determines the difference between the chroma signal SCb at the pixel P of interest and the chroma signal SCb at each of a total of four pixels, namely two pixels separated leftward (direction D1) by the predetermined number N2 or more from the pixel P of interest as the reference and two pixels separated rightward (direction D2) by the predetermined number N2 or more from the pixel P of interest as the reference, and determines that the pixel P of interest forms the local-maximum region A of the chroma plane PLCb in the horizontal direction, when every one of the differences is equal to or larger than the predetermined threshold value thc.

In step S14, using the chroma plane PLCb, the local-maximum-region detector 31 determines the difference between the chroma signal SCb at the pixel P of interest and the chroma signal SCb at each of a total of four pixels, namely two pixels separated upward (direction D1) by the predetermined number N2 or more from the pixel P of interest as the reference and two pixels separated downward (direction D2) by the predetermined number N2 or more from the pixel P of interest as the reference, and determines that the pixel P of interest forms the local-maximum region A of the chroma plane PLCb in the vertical direction, when every one of the differences is equal to or larger than the predetermined threshold value thc.

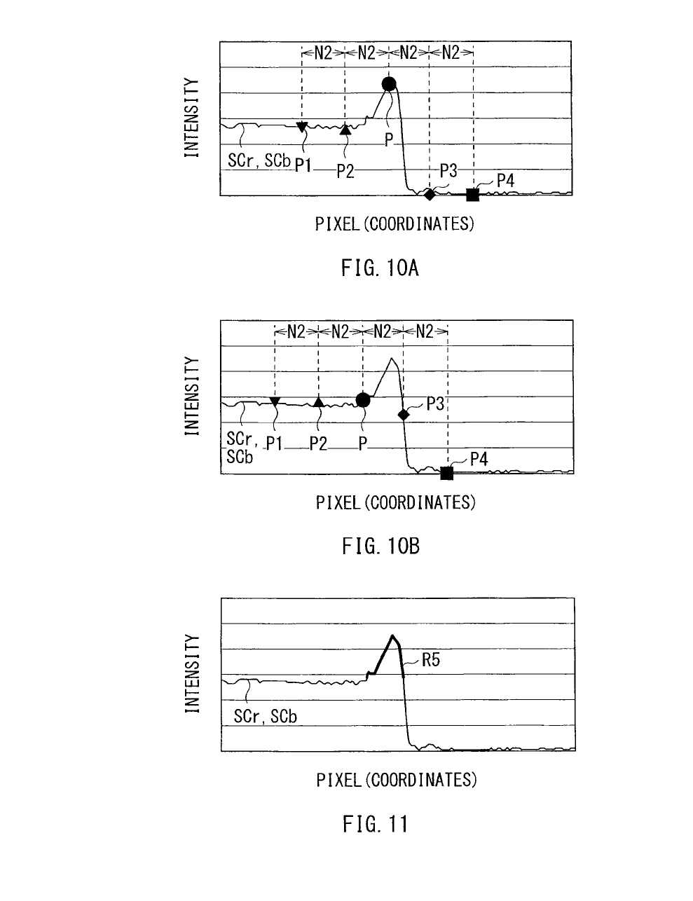

FIGS. 10A and 10B show the operations of the local-maximum-region detector 31 in steps S11 to S14. FIG. 10A shows the pixel P of interest forming the local-maximum region A, and FIG. 10B shows that the pixel P of interest does not form the local-maximum region A. In the description of this example, the predetermined threshold value the is set to “0”.

In step S11, for example, the local-maximum-region detector 31 may determine the difference between the chroma signal SCr at the pixel P of interest and at each of four pixels P1 to P4 separated from the pixel P of interest by the predetermined number N2 or more. In this example, the pixel P1 is located in a position set apart leftward from the pixel P of interest by (2×N2), the pixel P2 is located in a position set apart leftward from the pixel P of interest by N2, the pixel P3 is located in a position set apart rightward from the pixel P of interest by N2, and the pixel P4 is located in a position set apart rightward from the pixel P of interest by (2×N2).

In the example shown in FIG. 10A, the intensity of the chroma signal SCr at the pixel P of interest is higher than those of the chroma signals SCr at all of the four pixels P1 to P4. Accordingly, the local-maximum-region detector 31 determines that the pixel P of interest forms the local-maximum region A. In the example shown in FIG. 10B, the intensity of the chroma signal SCr at the pixel P of interest is about the same as those of the chroma signals SCr at the two pixels P1 and P2. When the intensity of the chroma signal SCr at the pixel P of interest is lower than that of the chroma signal SCr at any one of the four pixels P1 to P4, the local-maximum-region detector 31 determines that the pixel P of interest does not form the local-maximum region A.

FIG. 11 shows the local-maximum region A detected by the local-maximum-region detector 31. In each of steps S11 to S14, as mentioned above, the local-maximum-region detector 31 determines whether the pixel P of interest forms the local-maximum region A for each pixel P of interest. The local-maximum-region detector 31 detects the local-maximum region A (region R5) as a collection of pixels which are determined as forming the local-maximum region A. The local-maximum-region detector 31 then supplies the positions of the pixels forming the local-maximum regions A to the minimum-value detector 32 as four maps corresponding to the individual steps S11 to S14. The local-maximum-region detector 31 also outputs the chroma signals SCr at pixels belonging to the local-maximum regions A detected in steps S11 and S12, and the chroma signals SCb at pixels belonging to the local-maximum regions A detected in steps S13 and S14 as four maps corresponding to the individual four steps.

The minimum-value detector 32 sequentially selects the pixels forming the local-maximum region A detected by the local-maximum-region detector 31, and determines the minimum value Min of each of the chroma signals SCr and SCb in a predetermined zone near the selected pixel (pixel P of interest) and corresponding to the local-maximum region A.

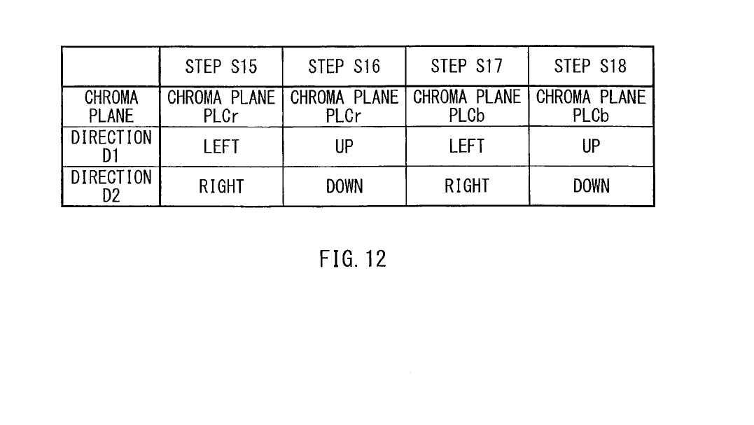

FIG. 12 illustrates the operation of the minimum-value detector 32. The minimum-value detector 32 executes four steps S15 to S18 as shown in FIG. 12. The minimum-value detector 32 determines the minimum value Min of the chroma signals SCr using the chroma plane PLCr (chroma signals SCr for a single frame image) in steps S15 and S16, and determines the minimum value Min of the chroma signals SCb using the chroma plane PLCb (chroma signals SCb for a single frame image) in steps S17 and S18. In other words, an arithmetic operation for reducing reddish color fringing is performed in steps S15 and S16, and an arithmetic operation for reducing bluish color fringing is performed in steps S17 and S18. In executing the arithmetic operations, the minimum-value detector 32 performs an integration operation in the horizontal direction in steps S15 and S17, and performs an integration operation in the vertical direction in steps S16 and S18.

Specifically, in step S15, using the chroma plane PLCr, the minimum-value detector 32 determines the minimum value Min of the chroma signals SCr, in a region extending from a pixel separated leftward (direction D1) from the pixel P of interest as a reference by a predetermined number N3 to a pixel separated rightward (direction D2) from the pixel P of interest as the reference by the predetermined number N3 and corresponding to the local-maximum region A.

In step S16, using the chroma plane PLCr, the minimum-value detector 32 determines the minimum value Min of the chroma signals SCr, in a region extending from a pixel separated upward (direction D1) from the pixel P of interest as the reference by the predetermined number N3 to a pixel separated downward (direction D2) from the pixel P of interest as the reference by the predetermined number N3 and corresponding to the local-maximum region A.

In step S17, using the chroma plane PLCb, the minimum-value detector 32 determines the minimum value Min of the chroma signals SCb, in a region extending from a pixel separated leftward (direction D1) from the pixel P of interest as the reference by the predetermined number N3 to a pixel separated rightward (direction D2) from the pixel P of interest as the reference by the predetermined number N3 and corresponding to the local-maximum region A.

In step S18, using the chroma plane PLCb, the minimum-value detector 32 determines the minimum value Min of the chroma signals SCb, in a region extending from a pixel separated upward (direction D1) from the pixel P of interest as the reference by the predetermined number N3 to a pixel separated downward (direction D2) from the pixel P of interest as the reference by the predetermined number N3 and corresponding to the local-maximum region A.

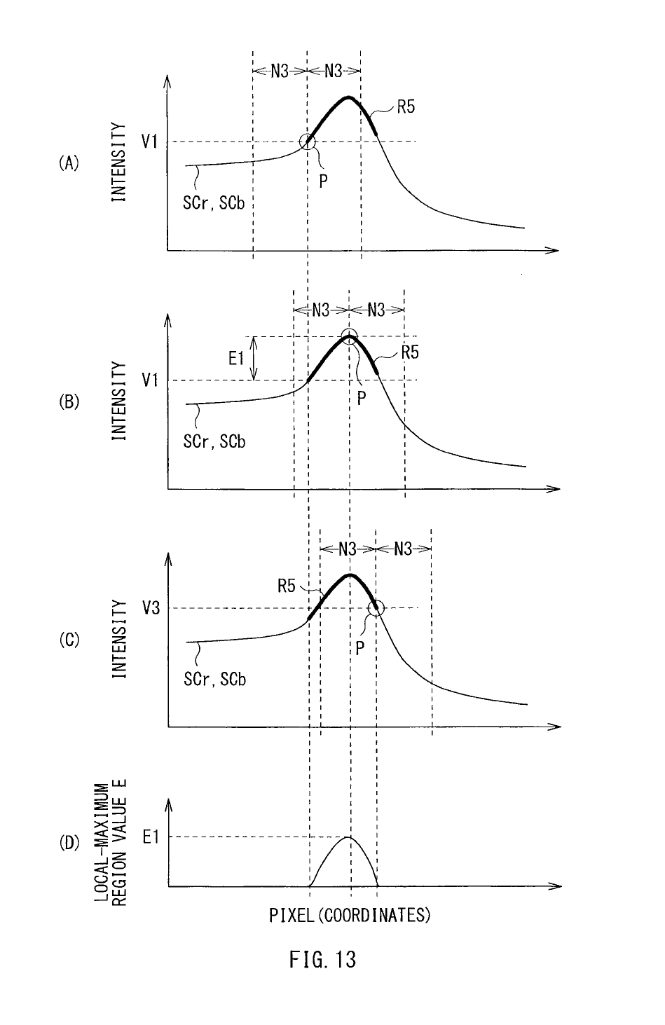

FIG. 13 illustrates the operations of the minimum-value detector 32 in steps S15 to S18. In step S15, for example, the minimum-value detector 32 may determine the minimum value Min of chroma signals SCr at those pixels located within a region separated from the pixel P of interest in the horizontal direction by the predetermined number N3 and belonging to the local-maximum region A. For example, when the pixel P of interest is the pixel at the left end of the local-maximum region A (region R5), as shown in FIG. 13A, the minimum value Min becomes a value V1 equal to the value of the chroma signal SCr at the pixel P of interest. For example, when the pixel P of interest is a pixel near the center of the local-maximum region A (region R5), as shown in FIG. 13B, the minimum value Min becomes the value V1. For example, when the pixel P of interest is the pixel at the right end of the local-maximum region A (region R5), as shown in FIG. 13C, the minimum value Min becomes a value V3 equal to the value of the chroma signal SCr at the pixel P of interest.

The minimum-value detector 32 determines the minimum value Min for each pixel P of interest in each of steps S15 to S18 in this manner. The minimum-value detector 32 then outputs the minimum values Min of the chroma signals SCr determined in steps S15 and S16, and the minimum values Min of the chroma signals SCb determined in steps S17 and S18, as four maps corresponding to the respective steps S15 to S18.

The local-maximum-region map generator 33 generates four local-maximum-region maps MM1 to MM4 containing the local-maximum region value E as an element for each pixel, based on the chroma signals SCr and SCb in the local-maximum region A detected by the local-maximum-region detector 31 and the minimum value Min detected by the minimum-value detector 32.

Specifically, the local-maximum-region map generator 33 determines the difference between the values at the same pixel (chroma signal SCr in the local-maximum region A and the corresponding minimum value Min) in the map generated in step S11 and the map generated in step S15, to thereby determine the local-maximum region value E at that pixel. Because the value of the chroma signal SCr at the pixel P of interest is equal to the corresponding minimum value Min (value V1) in (A) of FIG. 13, for example, the local-maximum region value E becomes “0” ((D) of FIG. 13). Because the value of the chroma signal SCr at the pixel P of interest is larger than the corresponding minimum value Min (value V1) in (B) of FIG. 13, for example, the local-maximum region value E becomes a value E1 which is the difference between the chroma signal SCr and the minimum value Min ((D) of FIG. 13). Because the value of the chroma signal SCr at the pixel P of interest is equal to the corresponding minimum value Min (value V3) in (C) of FIG. 13, for example, the local-maximum region value E becomes “0” (zero) ((D) of FIG. 13). The local-maximum-region map generator 33 sets the local-maximum region value E at a pixel which does not belong to the local-maximum region A to “0” (zero).

The local-maximum-region map generator 33 generates the local-maximum-region map MM1 by determining the local-maximum region values E at all the pixels in this manner. Likewise, the local-maximum-region map generator 33 generates the local-maximum-region map MM2 based on the maps generated in steps S12 and S16, generates the local-maximum-region map MM3 based on the maps generated in steps S13 and S17, and generates the local-maximum-region map MM4 based on the maps generated in steps S14 and S18.

As apparent from the above, the local-maximum-region calculating section 30 detects the local-maximum regions A of the chroma signals SCr and SCb in a frame image, sets the local-maximum region values E to values corresponding to the values of the chroma signals SCr and SCb in the local-maximum regions A, and sets the local-maximum region values E in regions other than the local-maximum regions A to “0”. This ensures sufficient reduction of color fringing. In other words, the chroma signals SCr and SCb become the maximum in the region where the color fringing is generated. Therefore, setting the local-maximum region values E to the values corresponding to the values of the chroma signals SCr and SCb makes it possible to efficiently reduce the color fringing.

The local-maximum-region calculating section 30 determines the local-maximum region A of each of the chroma signals SCr and SCb, and the minimum values Min of the chroma signals SCr and SCb in a predetermined zone near each of the pixels forming the local-maximum region A and corresponding to the local-maximum region A, and performs color correction based on the determined local-maximum regions A and minimum values Min. This ensures adequate reduction of color fringing with simple processing. In performing color correction, for example, it is necessary for the image processing device described in Japanese Unexamined Patent Application Publication No. 2011-205477 to discriminate the direction in which the luminance monotonously decreases, and determine at which pixel the monotonous decrease ends. This image processing device according to the Japanese Unexamined Patent Application Publication No. 2011-205477 is therefore apt to be affected by noise as mentioned above, and has a difficulty in discriminating whether the luminance is monotonously decreasing, which may complicate the processing. By way of contrast, the local-maximum-region calculating section 30 determines the local-maximum regions A of the chroma signals SCr and SCb, and the minimum values Min of the chroma signals SCr and SCb. Because those arithmetic operations are comparatively simple, it is possible to reduce the arithmetic-operational load and shorten the arithmetic operation time, thus ensuring an efficient arithmetic operation.

(Operation of Correcting Section 40)

The correction map generator 41 generates four correction maps MAP1 to MAP4 containing a correction amount M for each pixel as an element, based on the gain maps MG1 to MG4 and the local-maximum-region maps MM1 to MM4.

Specifically, the correction map generator 41 determines a product M1 of values at the same pixel (gain G and the local-maximum region value E) in the gain map MG1 and the local-maximum-region map MM1, and determines the correction amount M for that pixel based on the product M1.

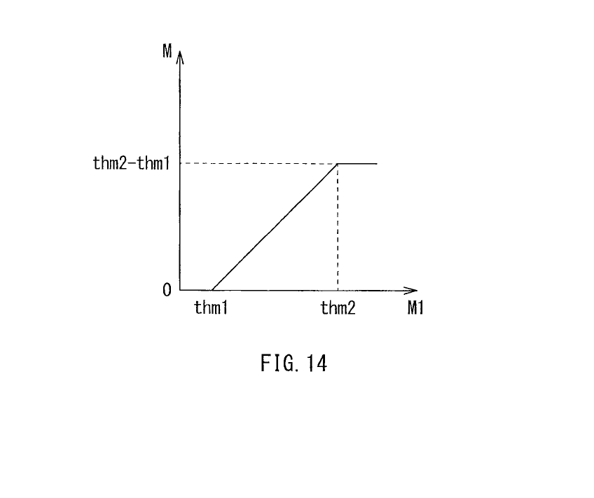

FIG. 14 shows an operation of determining the correction amount M at a certain pixel based on the product M1 at that pixel. The correction map generator 41 determines the correction amount M by substituting the product M1 in the following expression.

$$\begin{matrix}[ EQ . 4 ] & \\ M = \{ \begin{matrix}0 & ( M 1 ≦ th m 1 ) \\ M 1 - th m 1 & ( th m 1 < M 1 < th m 2 ) \\ th m 2 - th m 1 & ( th m 2 ≦ M 1 )\end{matrix} & ( 4 )\end{matrix}$$

The correction amount M is a linear function of the product M1 in a zone where the product M1 is larger than a value thm1 and less than a value thm2. For example, the value thm1 may be set to “0”, and the value thm2 may be set to “256”.

The correction map generator 41 determines the correction amounts M at all the pixels to generate the correction map MAP1. Likewise, the correction map generator 41 generates the correction map MAP2 based on the gain map MG2 and the local-maximum-region map MM2, generates the correction map MAP3 based on the gain map MG3 and the local-maximum-region map MM3, and generates the correction map MAP4 based on the gain map MG4 and the local-maximum-region map MM4.

The correcting section 40 performs color correction on the chroma signals SCr and SCb to reduce color fringing, based on the correction maps MAP1 to MAP4 generated by the correction map generator 41. Specifically, the correcting section 40 subtracts a larger one of values in the correction maps MAP1 and MAP2 at the same pixel from the chroma signal SCr at that pixel in the chroma plane PLCr, and subtracts a larger one of values in the correction maps MAP3 and MAP4 at the same pixel from the chroma signal SCb at that pixel in the chroma plane PLCb. The correcting section 40 performs such correction for all the pixels, and outputs the correction results as the chroma signals SCr2 and SCb2.

The image processing device 1 determines the gain maps MG1 to MG4 based on the luminance signal SY and the color signals SR and SB, determines the local-maximum-region maps MM1 to MM4 based on the chroma signals SCr and SCb, and performs correction based on the gain maps MG1 to MG4 and the local-maximum-region maps MM1 to MM4 in the above-described manner. This makes it possible to reduce color fringing more accurately. For example, because the image processing device described in Japanese Unexamined Patent Application Publication No. 2011-205477 may not cause color fringing in the direction of monotonously reducing the luminance, the accuracy in color correction may be reduced. Because the image processing device described in, for example, Japanese Unexamined Patent Application Publication No. 2009-268033 may perform color correction more than necessary at a low-luminance region adjoining a high-luminance region, the original color may be altered. By way of contrast, the image processing device 1 enhances the gain G in a region where color fringing is likely to occur, based on the luminance signal SY or the like, detects a region (local-maximum region A) where color fringing appears, based on the chroma signals SCr and SCb, and determines the correction amount M based on the enhanced gain G and the detected local-maximum region A. This makes it possible to adequately correct the color-fringing regions.

[Effect]

According to the present embodiment as described above, the local-maximum-region calculating section detects the local-maximum region of the chroma signal, and determines a correction amount, based on the chroma signal at each of the pixels forming the local-maximum region and the minimum of the chroma signals in a predetermined zone near the pixels and corresponding to the local-maximum region. Therefore, it is possible to adequately suppress color fringing.

According to the present embodiment, the integrators in the gain calculating section integrate color signals and luminance signals, thus making it possible to suppress the influence of noise on the correction operation.

[First Modification]

According to the embodiment described above, one gain calculating section 20 generates the gain maps MG1 to MG4, which is not restrictive. Instead, for example, a plurality of gain calculating sections may be provided to perform parallel processing. The following describes an example where two gain calculating sections are provided.

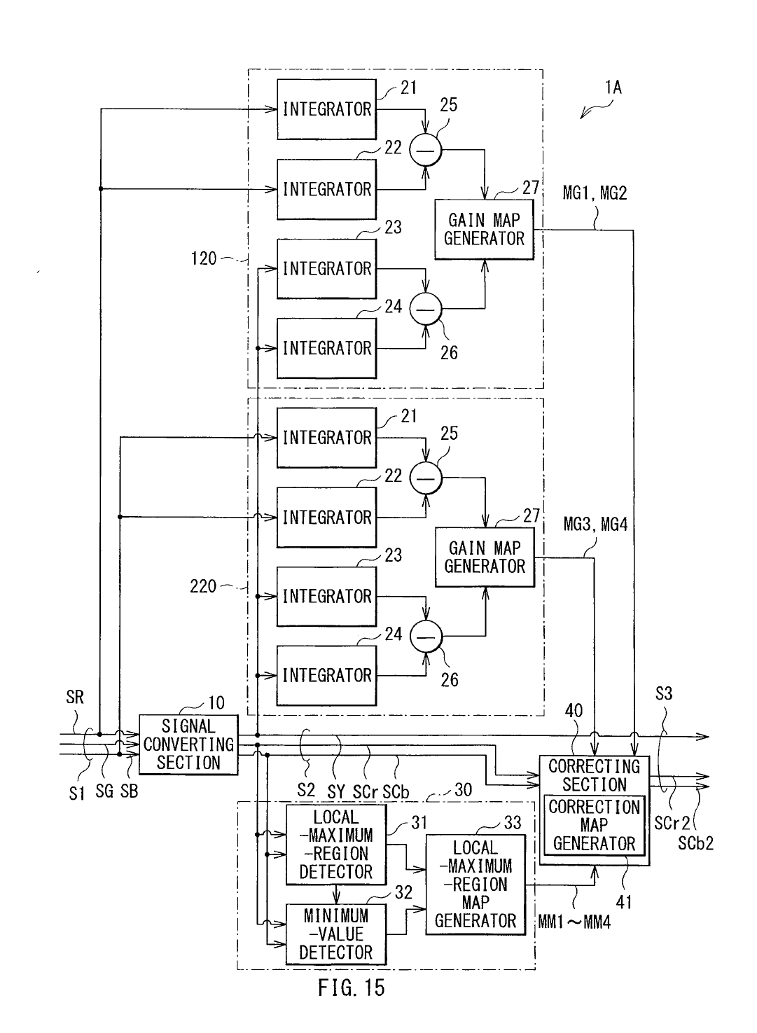

FIG. 15 shows a configurational example of an image processing device 1A according to the modification. The image processing device 1A includes two gain calculating sections 120 and 220. The gain calculating section 120 generates the gain maps MG1 and MG2 based on the color signal SR, and the gain calculating section 220 generates the gain maps MG3 and MG4 based on the color signal SB. The separate allotting of the process of generating the gain maps MG1 to MG4 to the two gain calculating sections 120 and 220 makes the processing time shorter.

[Second Modification]

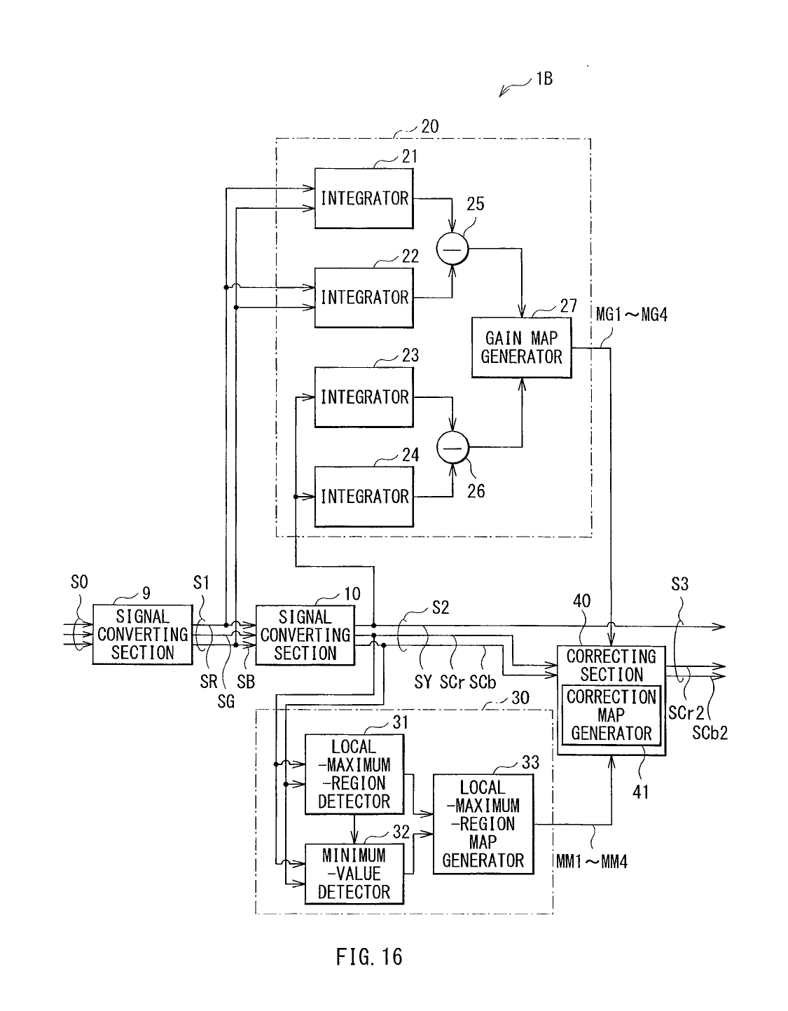

According to the embodiment described above, the image signal S1 is an RGB signal, which is not restrictive. For example, another type of image signal S0 may be treated as an input signal, and may be converted into an RGB signal to generate the image signal S1 as shown in FIG. 16. A signal of a complementary color (CMY or the like), an Lab signal, an HSV signal, a YUV signal, a YIQ signal or the like may be available as the image signal S0.

[Third Modification]

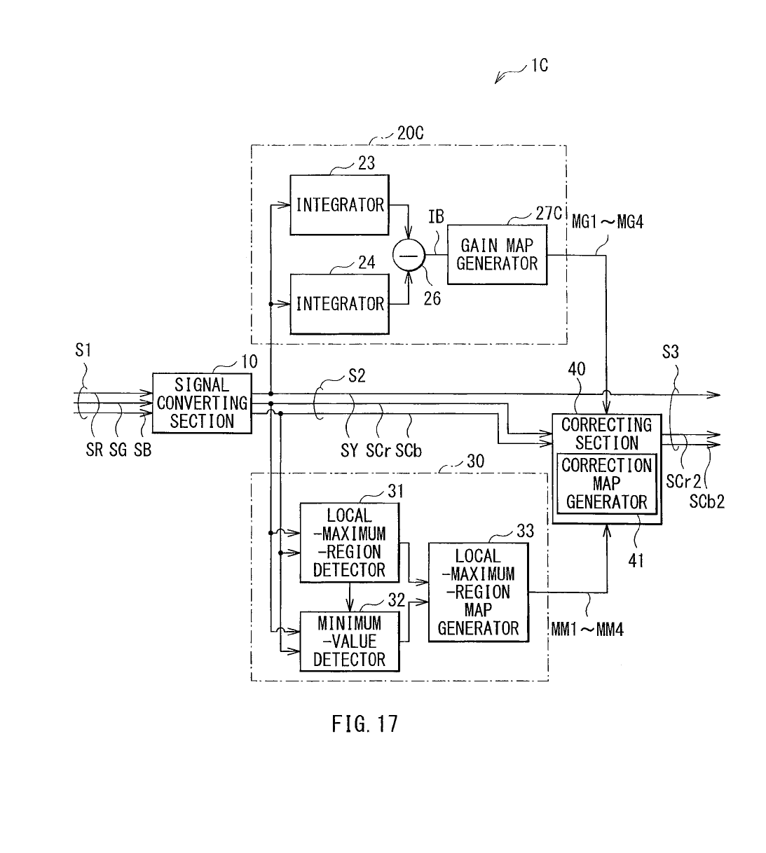

According to the embodiment described above, the gain calculating section 20 generates the gain maps MG1 to MG4 based on the luminance signal SY and the color signals SR and SB. However, this map generation is not restrictive. Alternatively, the gain maps MG1 to MG4 may be generated based only on the luminance signal SY, as shown in FIG. 17. An image processing device 1C according to a modification includes a gain calculating section 20C. The gain calculating section 20C generates the gain maps MG1 to MG4 based only on the luminance signal SY. The gain calculating section 20C is the gain calculating section 20 according to the above-described embodiment from which the integrators 21 and 22, and the subtracter 25 are removed. A gain map generator 27C according to this modification determines the gain G by substituting the difference signal IB into the following expression.

$$\begin{matrix}[ EQ . 5 ] & \\ G = \{ \begin{matrix}0 & ( I B ≦ th 3 ) \\ \frac{I B - th 3}{th 4 - th 3} & ( th 3 < I B < th 4 ) \\ 0 & ( th 4 ≦ I B )\end{matrix} & ( 5 )\end{matrix}$$

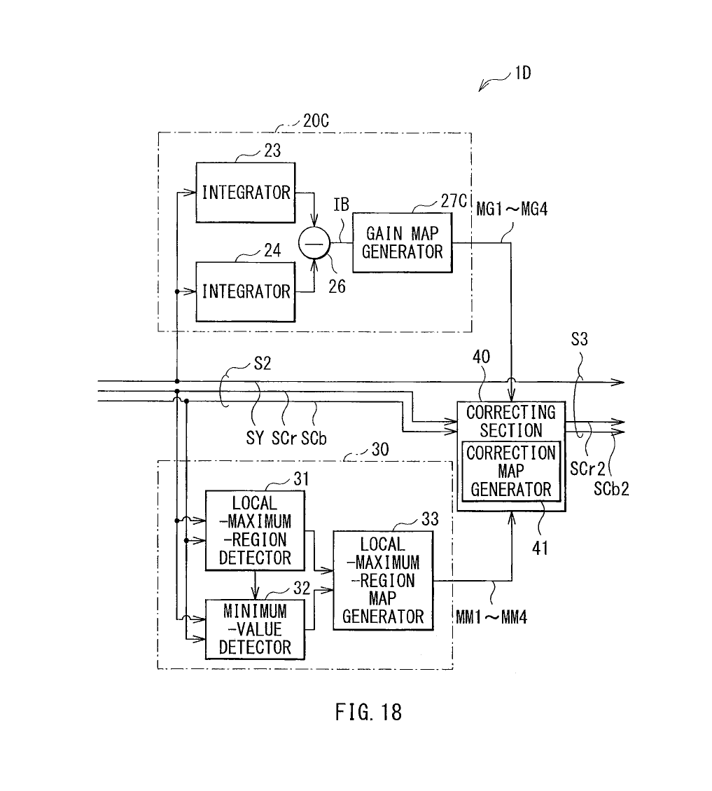

In such a case, as shown in FIG. 18, the signal converting section 10 may be removed too, so that the image signal S2 is treated as an input signal.

The configuration that permits the gain maps MG1 to MG4 to be generated based only on the luminance signal SY enables downsizing of the circuit scale at the price of slightly lower correction accuracy, thus making it possible to shorten the arithmetic processing time.

[Fourth Modification]

According to the embodiment and some of the modifications described above, the gain calculating section 20 generates the gain maps MG1 to MG4 based on the luminance signal SY, and the chroma signals SCr and SCb in steps S1 to S6. However, this map generation is not restrictive. The gain calculating section 20 may generate the gain maps MG1 and MG2 based on the luminance signal SY, and the chroma signal SCr in steps S1, S2, S5 and S6. This modification does not generate the gain maps MG3 and MG4 based on the chroma signal SCb, thus reducing the amount of arithmetic processing. This makes it possible to shorten the arithmetic processing time. In this case, desirably, the local-maximum-region calculating section 30 may not generate local-maximum-region maps MM3 and MM4 based on the chroma signal SCb.

Likewise, the gain calculating section 20 may generate the gain maps MG3 and MG4 based on the luminance signal SY, and the chroma signal SCb in steps S3 to S6. This modification does not generate the gain maps MG1 and MG2 based on the chroma signal SCr, thus making it possible to reduce the amount of arithmetic processing and shorten the arithmetic processing time as a consequence. In this case, desirably, the local-maximum-region calculating section 30 may not generate local-maximum-region maps MM1 and MM2 based on the chroma signal SCr.

[Fifth Modification]

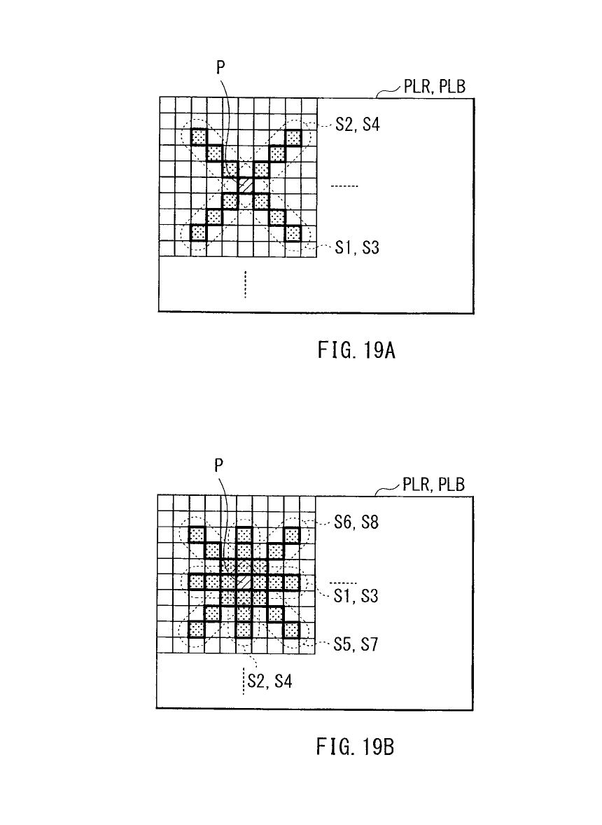

According to the embodiment described above, the gain calculating section 20 performs arithmetic operations for integration in the horizontal direction and the vertical direction. This integration is not restrictive. The arithmetic operations for integration may be performed in an oblique direction, for example, as shown in FIG. 19A, or the arithmetic operations for integration may be performed in the horizontal direction and the vertical direction in steps S1 to S4, and in an oblique direction in steps S5 to S8, as shown in FIG. 19B. In this case, desirably, the arithmetic operations for integration in steps S5 and S6 may be performed in similar directions. It is also desirable that the arithmetic operations for integration by the local-maximum-region calculating section 50 in steps S11 to S18 may be performed in similar directions.

[Sixth Modification]

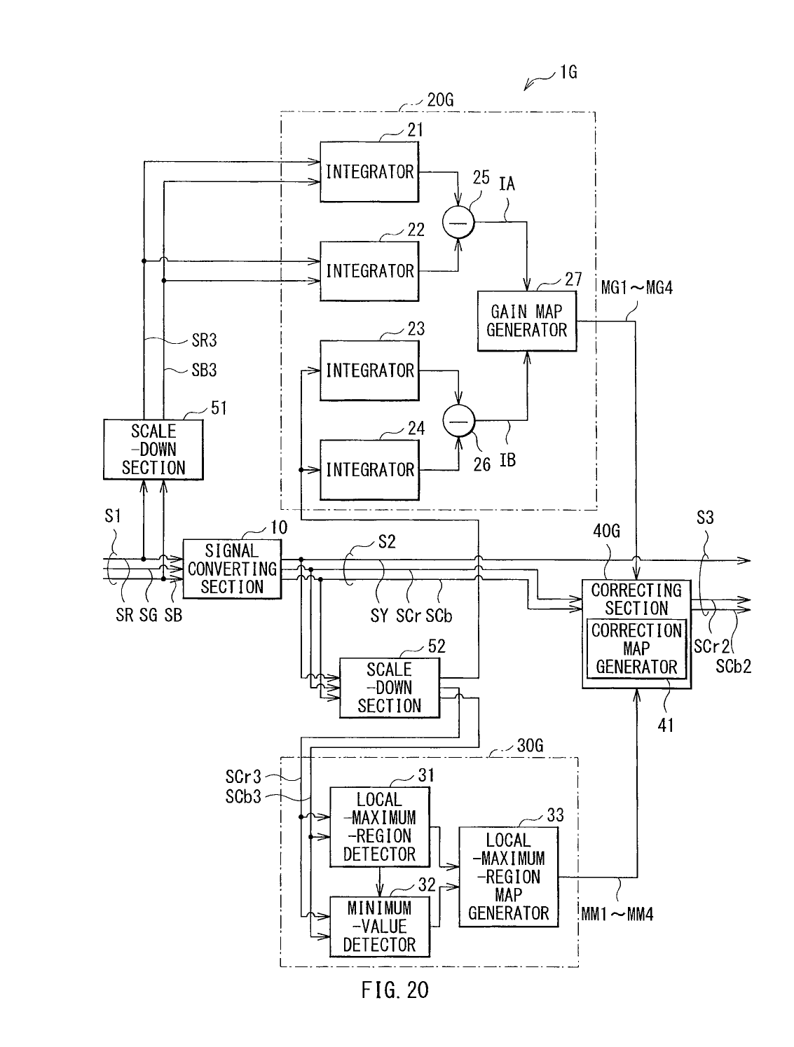

Although the gain calculating section 20 and the local-maximum-region calculating section 30 perform arithmetic operations using the color planes PLR and PLB, the luminance plane PLY, and the chroma planes PLCr and PLCb, the arithmetic operations are not restrictive. Arithmetic operations may be performed using scaled-down planes as shown in FIG. 20. An image processing device 1G according to this modification includes scale-down sections 51 and 52, and a correcting section 40G. The scale-down section 51 scales down a frame image supplied by an image signal S1 to generate scale-down color planes PLR3 and PLB3 (color signals SR3 and SB3). The scale-down section 52 scales down a frame image supplied by an image signal S2 to generate a scale-down luminance plane PLY3 (color signal SY3), and scale-down chroma planes PLCr3 and PLCb3 (chroma signals SCr3 and SCb3). The correcting section 40G enlarges the correction maps MAP1 to MAP4, generated by the correction map generator 41, by the scale-down ratios selected and scaled down by the scale-down sections 51 and 52 to restore the correction maps MAP1 to MAP4 to the original sizes, and performs arithmetic operations for color correction based on the enlarged correction maps. This configuration makes it possible to reduce the arithmetic operational burden on the gain calculating section 20, the local-maximum-region calculating section 30, and the like, and shorten the arithmetic operation time.

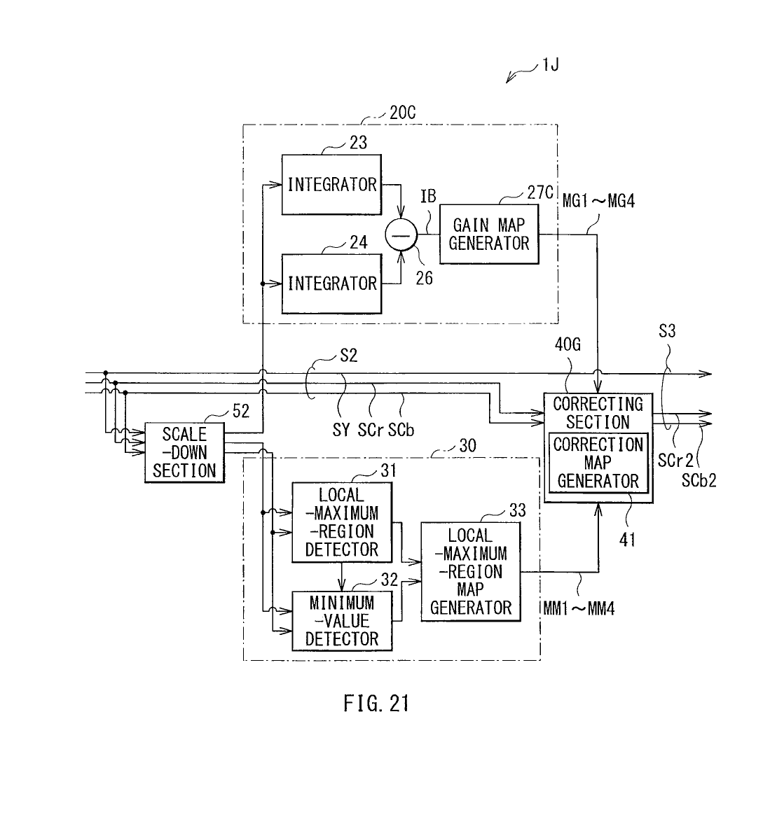

Although two scale-down sections 51 and 52 are provided in the sixth modification, this configuration is not restrictive, and a single scale-down section may be provided as shown in FIG. 21. This image processing device 1J is this modification adapted to the third modification (FIG. 18). The image processing device 1J includes one scale-down section 52 and the correcting section 40G. This configuration makes the image processing device 1J as advantageous as the image processing device 1G.

[Seventh Modification]

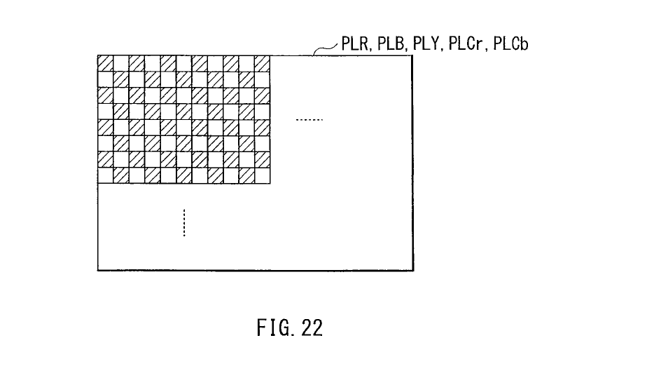

According to the embodiment described above, the gain calculating section 20 and the local-maximum-region calculating section 30 sequentially select all the pixels on the color planes PLR and PLB, the luminance plane PLY, and the chroma planes PLCr and PLCb, and perform arithmetic operations for each pixel selected (pixel P of interest). This operation is not restrictive; for example, the pixels may be thinned as shown in FIG. 22. FIG. 22 illustrates an operational example where the pixels of a frame image are thinned to ¼(hatched portions) of the entire pixels, and the pixel P of interest is sequentially selected from the ¼ of the entire pixels. This configuration makes it possible to reduce the arithmetic operational burden on the gain calculating section 20, the local-maximum-region calculating section 30, and the like, and shorten the arithmetic operation time.

[Eighth Modification]

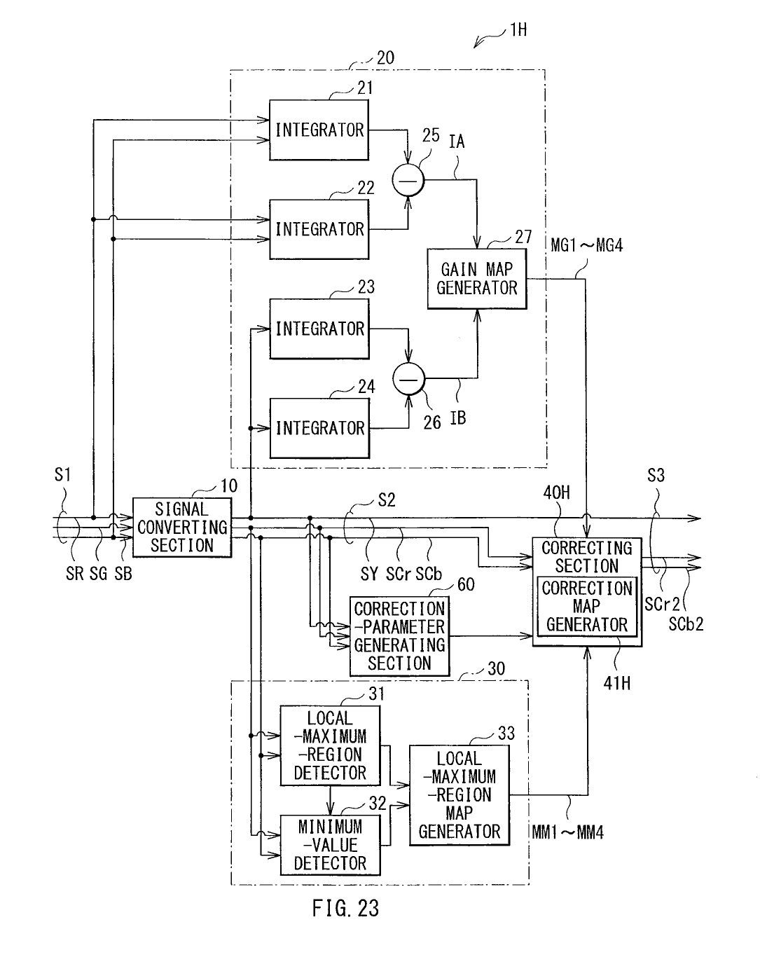

According to the embodiment described above, the correcting section 40 determines the correction amount M based on the gain maps MG1 to MG4 and the local-maximum-region maps MM1 to MM4, which is not restrictive. Instead, the correcting section 40 may determine the correction amount M based on the luminance signal SY, and the chroma signals SCr and SCb as shown in FIG. 23. Specifically, for example, the correction amount M may be determined based also on the luminance signal SY, and the chroma signals SCr and SCb of the pixel P of interest and of a pixel near the pixel P of interest. An image processing device 1H according to this modification includes a correction-parameter generating section 60, and a correcting section 40H. The correction-parameter generating section 60 determines a correction parameter based on the luminance signal SY, and the chroma signals SCr and SCb. The correcting section 40H performs correction based on parameters supplied from the gain calculating section 20 and the local-maximum-region calculating section 30, and the correction parameter supplied from the correction-parameter generating section 60.

[Ninth Modification]

According to the embodiment described above, the integrators 21 and 22 in the gain calculating section 20 integrate the color signals SR and SB to determine average values, and the subtracter 25 generates the difference signal IA based on the difference between the average values. However, this configuration is not restrictive; for example, the integrators 21 and 22 may integrate the color signals SR and SB, and the subtracter 25 may generate the difference signal IA based on the difference between the results of the integrations. Likewise, while the integrators 23 and 24 in the gain calculating section 20 integrate the luminance signals SY to determine average values, and the subtracter 26 generates the difference signal IB based on the difference between the average values, this is not restrictive. Alternatively, the integrators 23 and 24 may integrate the luminance signals SY, and the subtracter 26 may generate the difference signal IB based on the difference between the results of the integrations. In this case, desirably, the gain map generator 27 may change the values th1 to th4 in the expressions 2 and 3 for determining the gain G according to the predetermined number N1. In addition, a monotonous function, for example, may be used to make the range of the output values from the integrators 21 and 22 fall within a predetermined range.

[Tenth Modification]

Although the gain map generator 27 generates the gain maps MG1 to MG4 based on four maps of the difference signal IA and two maps of the difference signal IB according to the embodiment described above, the map generation is not limited. Alternatively, filtering may be performed on the four maps of the difference signal IA and two maps of the difference signal IB using a low-pass filter or the like, and the gain maps MG1 to MG4 may be generated based on the filtered maps. The filtering process may be carried out by, for example, temporarily storing maps in a RAM (Random Access Memory) or the like, and then filtering the maps using an FIR (Finite Impulse Response) filter or the like. To correct color fringing intensively, a gain may be further applied to each value on each map in the filtering process, or a process of enlarging a region on a map which has values of “0” or larger may be performed.

[Eleventh Modification]

According to the embodiment described above, the local-maximum-region detector 31 supplies the positions of pixels forming the local-maximum region A to the minimum-value detector 32 as four maps respectively corresponding to steps S11 to S14, which is not restrictive. For example, filtering may be performed on those maps using a median filter, an FIR filter or the like, and the maps subjected to the filtering process may be supplied to the minimum-value detector 32.

[Twelfth Modification]

Although the correcting section 40 corrects the chroma signals SCb and SCr based on the correction maps MAP1 to MAP4 generated by the correction map generator 41 according to the embodiment described above, the map correction is not limited. Alternatively, filtering may be performed on the correction maps MAP1 to MAP4 using a low-pass filter, a median filter or the like, and the chroma signals SCb and SCr may be corrected based on the filtered maps. To correct color fringing intensively, a gain may be further applied to each value on each map in the filtering process, or a process of enlarging a region on a map which has values of “0” or larger may be performed.

Although one embodiment and various modifications according to the present technology have been described by way of example, the present technology are not limited to the embodiment and modifications described above, and may be modified in various other forms.

For example, although the image processing device 1 according to the embodiment or the like described above outputs the image signal S3 which is an YCbCr signal, this is not restrictive. A signal converting section may be provided at the last stage of the device to convert the image signal into a signal of a complementary color (CMY or the like), an Lab signal, an HSV signal, a YUV signal, a YIQ signal or the like before the signal is output.

The image processing devices according to the embodiment and the modifications described above are adaptable to electronic devices, such as a video camera that takes moving pictures and a digital camera that takes still pictures. In other words, the image processing devices according to the embodiment and the modifications described above are adaptable to electronic devices in various fields which are capable of correcting color fringing of an image.

Furthermore, the technology encompasses any possible combination of some or all of the various embodiments described herein and incorporated herein.

It is possible to achieve at least the following configurations from the above-described example embodiments of the disclosure.

(1) An image processing device, including:

a detecting section configured to detect, from a frame image, a local-maximum region that is configured of pixels each having a color-difference signal value larger than color-difference signal values of surrounding pixels;

a determining section configured to determine an overlapping region where the local-maximum region overlaps with a first neighboring region of a pixel of interest that belongs to the local-maximum region, and to determine a minimum of color-difference signal values of pixels that belong to the overlapping region; and

a correcting section configured to correct a color-difference signal of the pixel of interest, based on both a color-difference signal value of the pixel of interest and the minimum of the color-difference signal values of pixels that belong to the overlapping region.

(2) The image processing device according to (1), wherein the correcting section corrects the color-difference signal of the pixel of interest, based on a difference between the color-difference signal value of the pixel of interest and the minimum of the color-difference signal values of pixels that belong to the overlapping region.
(3) The image processing device according to (1) or (2), wherein

the determining section determines, for the pixel of interest, a first minimum value and a second minimum value, the first minimum value being defined as a minimum of color-difference signal values of pixels arranged in a first direction within the overlapping region, and the second minimum value being defined as a minimum of the color-difference signal values of pixels arranged in a second direction within the overlapping region, and

the correcting section corrects the color-difference signal of the pixel of interest, based on both the color-difference signal value of the pixel of interest and the first and second minimum values.

(4) The image processing device according to (3), wherein the correcting section determines a first correction value based on both the color-difference signal value of the pixel of interest and the first minimum value, determines a second correction value based on both the color-difference signal value of the pixel of interest and the second minimum value, and then corrects the color-difference signal of the pixel of interest based on a larger one of the first correction value and the second correction value.
(5) The image processing device according to (1) or (3), wherein

the color-difference signal includes a first kind of color-difference signal and a second kind of color-difference signal,

the determining section determines a first minimum value and a second minimum value based on the first kind of color-difference signal, the first minimum value being defined as a minimum of first kind of color-difference signal values of pixels that are arranged in a first direction within the overlapping region, and the second minimum value being defined as a minimum of the first kind of color-difference signal values of pixels that are arranged in a second direction within the overlapping region, and determines a third minimum value and a fourth minimum value based on the second kind of color-difference signal, the third minimum value being defined as a minimum of second kind of color-difference signal values of pixels that are arranged in the first direction within the overlapping region, and the fourth minimum value being defined as a minimum of the second kind of color-difference signal values of pixels that are arranged in the second direction within the overlapping region, and

the correcting section corrects the first kind of color-difference signal of the pixel of interest based on both a first kind of color-difference signal value of the pixel of interest and the first and second minimum values for the first kind of color-difference signal, and corrects the second kind of color-difference signal of the pixel of interest based on both a second kind of color-difference signal value of the pixel of interest and the third and fourth minimum values for the second kind of color-difference signal.

(6) The image processing device according to (4), further including a gain determining section configured to determine a first gain and a second gain for the pixel of interest,

the gain determining section determining the first gain based on a first signal variation that is a luminance signal variation of the pixels arranged in the first direction, and determining a second gain based on a second signal variation that is a luminance signal variation in the second direction,

wherein the correcting section adjusts the first correction value based on the first gain, and adjusts the second correction value based on the second gain.

(7) The image processing device according to (6), wherein

the first signal variation is a difference between a first average value and a second average value, the first average value being defined as an average value of the luminance signals of pixels arranged in a predetermined zone on one side of the pixel of interest in the first direction, and the second average value being defined as an average value of the luminance signals of pixels arranged in a predetermined zone on other side of the pixel of interest in the first direction, and

the second signal variation is a difference between a third average value and a fourth average value, the third average value being defined as an average value of the luminance signals of pixels arranged in a predetermined zone on one side of the pixel of interest in the second direction, and the fourth average value being defined as an average value of the luminance signals of pixels arranged in a predetermined zone on other side of the pixel of interest in the second direction.

(8) The image processing device according to (6) or (7), wherein

the first gain increases as the first signal variation increases, and

the second gain increases as the second signal variation increases.

(9) The image processing device according to any one of (6) to (8), further including a converting section configured to convert a color signal into the color-difference signal and the luminance signal,

wherein the gain determining section determines, for the pixel of interest, the first gain based on both the first signal variation and a third signal variation that is a color signal variation of the pixels arranged in the first direction, and determines the second gain based on both the second signal variation and a fourth signal variation that is a color signal variation of the pixels arranged in the second direction.

(10) The image processing device according to any one of (3) to (9), wherein

the first direction is a horizontal direction, and the second direction is a vertical direction.

(11) The image processing device according to any one of (3) to (9), wherein

the first direction is a direction along a straight line passing through both an upper left pixel located on a upper left side of the pixel of interest and a lower right pixel located on a lower right side of the pixel of interest, and

the second direction is a direction along a straight line passing through both a lower left pixel located on a lower left side of the pixel of interest and an upper right pixel located on a upper right side of the pixel of interest.

(12) The image processing device according to any one of (1) to (11), wherein the correcting section corrects the color-difference signal of the pixel of interest based on color-difference signals and luminance signals of the pixel of interest and its neighboring pixels, as well as based on the difference between the color-difference signal value of the pixel of interest and the minimum of the color-difference signal values of pixels that belong to the overlapping region.
(13) The image processing device according to any one of (1) to (12), wherein the determining section selects, one by one, the pixel of interest from all or some of pixels in the frame image.
(14) The image processing device according to (1) or (13), further including a scale-down section generating a scale-down frame image based on the frame image, wherein

the detecting section detects the local-maximum region from the scale-down frame image, and

the correcting section produces a scale-down correction amount map for the scale-down frame image based on both the color-difference signal value of the pixel of interest and the minimum of the color-difference signal values, produces a correction amount map through enlarging the scale-down correction amount map, and then corrects the color-difference signals of pixels in the frame image based on the correction amount map.

(15) The image processing device according to any one of (1) to (14), wherein the detecting section detects the local-maximum region through comparing a color-difference signal of a pixel in the frame image with color-difference signals of a plurality of pixels located outside a second neighboring region of the pixel.
(16) An image processing method, including:

detecting, from a frame image, a local-maximum region that is configured of pixels each having a color-difference signal value larger than color-difference signal values of surrounding pixels;

determining an overlapping region where the local-maximum region overlaps with a first neighboring region of a pixel of interest that belongs to the local-maximum region;

determining a minimum of color-difference signal values of pixels that belong to the overlapping region; and

correcting a color-difference signal of the pixel of interest, based on both a color-difference signal value of the pixel of interest and the minimum of the color-difference signal values of pixels that belong to the overlapping region.

(17) A non-transitory tangible medium having a computer-readable program embodied therein, the computer-readable program allowing, when executed by an image processing device, the image processing device to implement an image processing method, the method including:

detecting, from a frame image, a local-maximum region that is configured of pixels each having a color-difference signal value larger than color-difference signal values of surrounding pixels;

determining an overlapping region where the local-maximum region overlaps with a first neighboring region of a pixel of interest that belongs to the local-maximum region;

determining a minimum of color-difference signal values of pixels that belong to the overlapping region; and

correcting a color-difference signal of the pixel of interest, based on both a color-difference signal value of the pixel of interest and the minimum of the color-difference signal values of pixels that belong to the overlapping region.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device, comprising:
a detecting section configured to detect, from a frame image, a local-maximum region that is configured of pixels each having a color-difference signal value larger than color-difference signal values of surrounding pixels;
a determining section configured to determine an overlapping region where the local-maximum region overlaps with a first neighboring region of a pixel of interest that belongs to the local-maximum region, and to determine a minimum of color-difference signal values of pixels that belong to the overlapping region; and
a correcting section configured to correct a color-difference signal of the pixel of interest, based on both a color-difference signal value of the pixel of interest and the minimum of the color-difference signal values of pixels that belong to the overlapping region.

2. The image processing device according to claim 1, wherein the correcting section corrects the color-difference signal of the pixel of interest, based on a difference between the color-difference signal value of the pixel of interest and the minimum of the color-difference signal values of pixels that belong to the overlapping region.

3. The image processing device according to claim 1, wherein
the determining section determines, for the pixel of interest, a first minimum value and a second minimum value, the first minimum value being defined as a minimum of color-difference signal values of pixels arranged in a first direction within the overlapping region, and the second minimum value being defined as a minimum of the color-difference signal values of pixels arranged in a second direction within the overlapping region, and
the correcting section corrects the color-difference signal of the pixel of interest, based on both the color-difference signal value of the pixel of interest and the first and second minimum values.

4. The image processing device according to claim 3, wherein the correcting section determines a first correction value based on both the color-difference signal value of the pixel of interest and the first minimum value, determines a second correction value based on both the color-difference signal value of the pixel of interest and the second minimum value, and then corrects the color-difference signal of the pixel of interest based on a larger one of the first correction value and the second correction value.

5. The image processing device according to claim 1, wherein
the color-difference signal includes a first kind of color-difference signal and a second kind of color-difference signal,
the determining section determines a first minimum value and a second minimum value based on the first kind of color-difference signal, the first minimum value being defined as a minimum of first kind of color-difference signal values of pixels that are arranged in a first direction within the overlapping region, and the second minimum value being defined as a minimum of the first kind of color-difference signal values of pixels that are arranged in a second direction within the overlapping region, and determines a third minimum value and a fourth minimum value based on the second kind of color-difference signal, the third minimum value being defined as a minimum of second kind of color-difference signal values of pixels that are arranged in the first direction within the overlapping region, and the fourth minimum value being defined as a minimum of the second kind of color-difference signal values of pixels that are arranged in the second direction within the overlapping region, and
the correcting section corrects the first kind of color-difference signal of the pixel of interest based on both a first kind of color-difference signal value of the pixel of interest and the first and second minimum values for the first kind of color-difference signal, and corrects the second kind of color-difference signal of the pixel of interest based on both a second kind of color-difference signal value of the pixel of interest and the third and fourth minimum values for the second kind of color-difference signal.

6. The image processing device according to claim 4, further comprising a gain determining section configured to determine a first gain and a second gain for the pixel of interest,
the gain determining section determining the first gain based on a first signal variation that is a luminance signal variation of the pixels arranged in the first direction, and determining a second gain based on a second signal variation that is a luminance signal variation in the second direction,
wherein the correcting section adjusts the first correction value based on the first gain, and adjusts the second correction value based on the second gain.

7. The image processing device according to claim 6, wherein
the first signal variation is a difference between a first average value and a second average value, the first average value being defined as an average value of the luminance signals of pixels arranged in a predetermined zone on one side of the pixel of interest in the first direction, and the second average value being defined as an average value of the luminance signals of pixels arranged in a predetermined zone on other side of the pixel of interest in the first direction, and
the second signal variation is a difference between a third average value and a fourth average value, the third average value being defined as an average value of the luminance signals of pixels arranged in a predetermined zone on one side of the pixel of interest in the second direction, and the fourth average value being defined as an average value of the luminance signals of pixels arranged in a predetermined zone on other side of the pixel of interest in the second direction.

8. The image processing device according to claim 6, wherein
the first gain increases as the first signal variation increases, and
the second gain increases as the second signal variation increases.

9. The image processing device according to claim 6, further comprising a converting section configured to convert a color signal into the color-difference signal and the luminance signal,
wherein the gain determining section determines, for the pixel of interest, the first gain based on both the first signal variation and a third signal variation that is a color signal variation of the pixels arranged in the first direction, and determines the second gain based on both the second signal variation and a fourth signal variation that is a color signal variation of the pixels arranged in the second direction.

10. The image processing device according to claim 3, wherein
the first direction is a horizontal direction, and the second direction is a vertical direction.

11. The image processing device according to claim 3, wherein
the first direction is a direction along a straight line passing through both an upper left pixel located on a upper left side of the pixel of interest and a lower right pixel located on a lower right side of the pixel of interest, and
the second direction is a direction along a straight line passing through both a lower left pixel located on a lower left side of the pixel of interest and an upper right pixel located on a upper right side of the pixel of interest.

12. The image processing device according to claim 2, wherein the correcting section corrects the color-difference signal of the pixel of interest based on color-difference signals and luminance signals of the pixel of interest and its neighboring pixels, as well as based on the difference between the color-difference signal value of the pixel of interest and the minimum of the color-difference signal values of pixels that belong to the overlapping region.

13. The image processing device according to claim 1, wherein the determining section selects, one by one, the pixel of interest from all or some of pixels in the frame image.

14. The image processing device according to claim 1, further comprising a scale-down section generating a scale-down frame image based on the frame image, wherein
the detecting section detects the local-maximum region from the scale-down frame image, and
the correcting section produces a scale-down correction amount map for the scale-down frame image based on both the color-difference signal value of the pixel of interest and the minimum of the color-difference signal values, produces a correction amount map through enlarging the scale-down correction amount map, and then corrects the color-difference signals of pixels in the frame image based on the correction amount map.

15. The image processing device according to claim 1, wherein the detecting section detects the local-maximum region through comparing a color-difference signal of a pixel in the frame image with color-difference signals of a plurality of pixels located outside a second neighboring region of the pixel.

16. An image processing method, comprising:
detecting, from a frame image, a local-maximum region that is configured of pixels each having a color-difference signal value larger than color-difference signal values of surrounding pixels;
determining an overlapping region where the local-maximum region overlaps with a first neighboring region of a pixel of interest that belongs to the local-maximum region;
determining a minimum of color-difference signal values of pixels that belong to the overlapping region; and
correcting a color-difference signal of the pixel of interest, based on both a color-difference signal value of the pixel of interest and the minimum of the color-difference signal values of pixels that belong to the overlapping region.

17. A non-transitory tangible medium having a computer-readable program embodied therein, the computer-readable program allowing, when executed by an image processing device, the image processing device to implement an image processing method, the method comprising:
detecting, from a frame image, a local-maximum region that is configured of pixels each having a color-difference signal value larger than color-difference signal values of surrounding pixels;
determining an overlapping region where the local-maximum region overlaps with a first neighboring region of a pixel of interest that belongs to the local-maximum region;
determining a minimum of color-difference signal values of pixels that belong to the overlapping region; and
correcting a color-difference signal of the pixel of interest, based on both a color-difference signal value of the pixel of interest and the minimum of the color-difference signal values of pixels that belong to the overlapping region.
